(19) United States
(12) Patent Application Publication
(10) Pub. No.: US 2024/0088825 A1
(43) Pub. Date: Mar. 14, 2024

(54) SOLAR ARRAY ATTACHABLE TO STRUCTURE AND INCLUDING STOWABLE SOLAR MODULE

(71) Applicant: Portable Solar Inc., Miami, FL (US)

(72) Inventors: Samuel Marcus-Flack Truthseeker, Austin, TX (US); Dennis Nickerson, Miami, FL (US)

(21) Appl. No.: 18/455,824

(22) Filed: Aug. 25, 2023

Related U.S. Application Data
(60) Provisional application No. 63/404,706, filed on Sep. 8, 2022.

(51) Int. Cl. H02S 30/20

(52) U.S. Cl. CPC H02S 30/20

(57) ABSTRACT

A solar array attachable to a structure includes a solar module and a mount. The structure includes a wall having a top and a bottom and extending at least in part vertically. The mount attaches the solar module to the wall of the structure between the top and the bottom of the wall. The solar module is movable relative to the structure between a first position and a second position when the mount is attached to the structure. The solar module is stowed adjacent the wall of the structure when the solar module is in the first position. The solar module extends outward from the wall when the solar module is in the second position.

### CROSS-REFERENCE TO RELATED APPLICATIONS

This application claims the benefit of priority to U.S. Provisional Patent Application No. 63/404,706, filed on Sep. 8, 2022, the entire contents and disclosure of which are incorporated by reference in their entirety.

### FIELD

The field relates generally to solar arrays, and in particular to solar arrays attached to structures and including solar modules that are positionable in a stowed position.

### BACKGROUND

A solar photovoltaic (PV) module converts solar energy into useful forms of energy such as electricity. A PV module may include a series of PV cells in an assembly. Due to the fragility of the cells and the harsh environmental conditions they are often exposed to, the cells are often encapsulated in a rigid laminate.

Solar modules are sometimes attached to structures such as homes or commercial buildings and connected to provide energy for use in the structures. For example, solar modules are installed on roofs of homes and commercial buildings to form rooftop solar systems by securing mounts through penetrations in the roof. The solar modules may provide solar power options for a variety of structures to provide energy for on-site or off-site use. Because solar modules are installed on more and more structures, the increased access to solar power options could lead to more wide-spread adoption of solar power as a sustainable energy form.

Factory-built structures are assembled at a first location (e.g., a factory) and shipped to a second location (e.g., an installation location) and typically can be produced at lower cost than traditional structures built on site. For example, factory-built structures are assembled on an assembly line using standardized products. The factory-built structure industry is a low cost and low margin industry and is profitable by accelerating the throughput of structures through the assembly line process with the least amount of labor. Products such as customized solar modules slow down the assembly line or require specialized skills and are not adopted by the industry because the customized products tend to reduce profit per structure and slow down the manufacturing processes for structures using the customized products and for structures without the customized products. As a result, solar arrays for factory-built structures, if they are even available, have typically been more expensive for end users than the same product installed as a retrofit on structures.

In addition, solar modules are not typically attached to roofs of factory-built structures as required by rooftop solar systems because (1) the complexity of installation of the rooftop solar systems require specialized skill that is not within the standard construction practices of factory-built structure builders or installers, (2) the roofs of factory-built structures are typically built to the limits of code and cannot support the extra weight or point loads imparted by a rooftop solar system, and (3) loads that would be produced by solar modules that are attached to a roof of a factory-built structure during shipping to an installation destination would be more than the design load of the solar modules and may result in damage of the modules or structure during shipping.

Factory-built structures are typically less expensive than site-built structures and may be the only option for people with lower incomes to purchase a home, even though the factory-built structures may not provide the same options as site-built structures. For example, factory-built structures do not currently provide the same options for solar power as site-built structures. Accordingly, people buying factory-built structures (often home buyers having lower-incomes) may not have equal access to solar power options as people who are able to afford site-built structures.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

In one aspect, a solar array attachable to a structure includes a solar module and a mount. The structure includes a wall having a top and a bottom and extending at least in part vertically. The mount attaches the solar module to the wall of the structure between the top and the bottom of the wall. The solar module is movable relative to the structure between a first position and a second position when the mount is attached to the structure. The solar module is stowed adjacent to the wall of the structure when the solar module is in the first position. The solar module extends outward from the wall when the solar module is in the second position.

In another aspect, a factory-built structure is assembled at a first location and shipped to a second location. The factory-built structure includes a wall, a solar module, and a mount attached to the solar module and the wall. The solar module is movable relative to the factory-built structure between a first position and a second position. The solar module is stowed adjacent to the wall of the factory-built structure when the solar module is in the first position. The solar module extends outward from the wall when the solar module is in the second position.

In another aspect, a structure includes a factory-built structure and a substructure. The factory-built structure is assembled at a first location and shipped to a second location. The substructure includes a solar module and a mount attached to the factory-built structure and to the solar module. The solar module is movable relative to the factory-built structure between a first position and a second position. The solar module is stowed adjacent to the factory-built structure when the solar module is in the first position. The solar module extends outward from the factory-built structure when the solar module is in the second position.

In another aspect, a method of assembling a solar array for a factory-built structure includes attaching a mount to a wall of the factory-built structure. The factory-built structure is assembled at a first location and shipped to a second location. The method also includes attaching a support for a solar module to the mount. The solar module is movable relative to the factory-built structure between a first position and a second position when the mount is attached to the factory-built structure and to the solar module. The solar module is stowed adjacent to the wall of the factory-built structure when the solar module is in the first position. The solar module extends outward from the wall when the solar module is in the second position. The method further includes positioning the solar module in the first position to prepare the factory-built structure for shipment to the second location with the solar array attached to the factory-built structure.

In another aspect, a factory-built structure is assembled at a first location and shipped to a second location. The factory-built structure includes a wall, and a mount to attach a solar module to the factory-built structure. The solar module is attachable to the mount at the assembly location or the second location. The solar module is movable relative to the factory-built structure between a first position and a second position when the mount is attached to the factory-built structure and to the solar module. The solar module is stowed adjacent the factory-built structure when the solar module is in the first position. The solar module extends outward from the wall when the solar module is in the second position.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is a perspective of a portion of a structure including a solar array attached to walls of the structure, the solar array including solar modules attached on an end wall of the structure in a deployed position and solar modules attached on a long wall of the structure in a stowed position.

FIG. 2 is a perspective of a portion of the structure and the solar array of FIG. 1, the solar array including solar modules forming a 2-panel awning and solar modules forming a 3-panel awning.

FIG. 3A is a perspective of a portion of the structure of FIGS. 1 and 2, illustrating mounts required to install the solar modules along the long wall of the structure.

FIG. 3B is an elevation view of a portion of the structure of FIGS. 1-3A, illustrating the mounts required to install the solar modules along the long wall of the structure.

FIG. 4 is a perspective of a portion of the structure of FIGS. 1-3B, illustrating a support of the solar array in a stow position and attached to a mount at a lower location on the wall.

FIG. 5 is a side view of one of the stowed solar modules of FIG. 1, attached to the mounts of the structure of FIGS. 1-3B with the wall of the structure removed to show the attachment devices connecting the mounts to a structural member of the structure, the solar array including a top attachment assembly and a bottom attachment assembly.

FIG. 6 is a perspective of the top attachment assembly of the solar array of FIGS. 1 and 5, with the solar module and the support in a stow position, the top attachment assembly arranged for attaching the solar modules to the structure.

FIG. 7 is a perspective of the bottom attachment assembly of the solar array of FIGS. 1 and 5 with the solar module and the support in a stow position.

FIG. 8A is a perspective of a portion of the structure of FIG. 1, with an installed mount located at a bottom location and prior to attachment of the support.

FIG. 8B is a perspective of a portion of the structure of FIG. 1, with an installed mount located at the bottom location with an installed support attached to the mount and in a deployed position.

FIG. 9A is a schematic side view of a portion of the structure and the stowed solar module of FIG. 1 prior to release of a bottom side of the solar module from a lower mount by an installer.

FIG. 9B is a schematic side view of a portion of the structure and the solar array of FIG. 1 illustrating an installer lifting the solar module out of the stow position and towards a deployed position.

FIG. 9C is a side view of a portion of the structure of FIG. 1 illustrating the solar module and the support at a deployed position.

FIG. 10 is a side view of a portion of the structure of FIG. 1 with the solar module in a deployed position and illustrating a flashing at an interface of the structure and the solar module.

FIG. 11A is a top view of solar modules forming a 2-panel solar awning.

FIG. 11B is a bottom view of the solar modules of FIG. 11A.

FIG. 12 is a perspective of a shipping unit for shipping solar modules assembled as solar awnings, the shipping unit containing seven solar awnings.

FIG. 13A is a perspective of a support in a first, collapsed position.

FIG. 13B is a perspective of the support of FIG. 13A in a second, extended position.

FIG. 14 is a perspective of a portion of the structure of FIG. 1 illustrating a connection of the solar module to a support.

FIG. 15 is a perspective of a portion of the structure of FIG. 1 illustrating a connection of the solar module to a mount.

FIG. 16 is a perspective of a kit including pre-assembled supports in a stow configuration and packaged for shipping.

FIG. 17 is a perspective of vehicles and installers moving solar awnings provided in a factory-built configuration including 2-panel and 3-panel solar awnings along with hardware in shipping units.

FIG. 18A is an underside perspective of an alternative solar awning including solar modules and an extended back rail.

FIG. 18B is a top perspective of the solar awning of FIG. 18A with the extended back rail.

FIG. 19A is an underside perspective of the solar awning of FIGS. 18A and 18B installed on a structure.

FIG. 19B is an underside perspective of an alternative solar awning installed on a structure and including solar modules and a mid-span support extending across the extended back rail and along an extension of the solar module.

FIG. 19C is an underside perspective of an alternative solar awning installed on a structure and including solar modules and covers on the underside of the solar modules.

FIG. 20 is a side view of a solar array including a solar module in a deployed position and a wall mount extension assembly for supporting the module such that the module extends beyond an eave of a roof of the structure in the deployed position.

FIG. 21 is an enlarged side view of a portion of the wall mount extension assembly for the solar module of FIG. 20.

FIG. 22 is a side view of the solar module of FIG. 20 in the stow position with the wall mount extension assembly folded to allow for a flush to structure position.

FIG. 23A is a perspective of the wall mount extension assembly of FIGS. 20-22 in a first position.

FIG. 23B is a perspective of the wall mount extension assembly in a second position.

FIG. 23C is a perspective of the wall mount extension assembly in a third position.

FIG. 23D is a perspective of the wall mount extension assembly in a fourth position.

FIG. 24A is a back perspective of the wall mount extension assembly in the fourth position.

FIG. 24B is a back perspective of the wall mount extension assembly including flashing tape and attachment devices and in the fourth position.

FIG. 25A is a perspective of a portion of a support of a solar array in a first position and illustrating a release mechanism of the support.

FIG. 25B is a perspective of a portion of the support of the solar array in FIG. 25A in a second position, and illustrating the release mechanism in a locked position.

FIG. 26 is an elevation of a portion of the structure and the solar array of FIG. 1, illustrating a first module of the solar array in a stowed position, and a second module of the solar array in a deployed position.

FIG. 27 is a perspective of a portion of the structure and the solar array of FIG. 26 illustrating features for securing wires of the solar array.

FIG. 28 is an underside perspective of a solar module of a solar array illustrating power electronics of the solar array.

FIG. 29 is an underside perspective of a solar module of a solar array illustrating a portion of a mount for attaching to a structure with a hinge for positioning the solar module relative to the structure.

FIG. 30 is a perspective of an alternative embodiment of solar module illustrating a mount with a hinge for positioning the solar module relative to the structure.

FIG. 31 is another perspective of the solar module of FIG. 30.

FIG. 32 is a perspective of a kit including solar modules preassembled as solar awnings for installation on a structure.

FIG. 33 is an underside perspective of the solar awnings of FIG. 32.

FIG. 34 is a side view of the solar awnings of FIGS. 32 and 33.

FIG. 35 is a side view of the solar awnings of FIGS. 32-34 in the shipping unit of FIG. 12.

FIG. 36 is a side view of an alternative embodiment of solar modules and an extension assembly attached to a structure.

FIG. 37 is an enlarged side view of the extension assembly of FIG. 36.

FIG. 38 is a perspective of the solar modules and the structure of FIG. 36, the solar modules in a deployed position.

FIG. 39 is a side view of the solar modules, the extension assembly, and the structure of FIG. 36 illustrating a connection of the extension assembly to the structure.

FIG. 40 is a perspective of the solar modules, the extension assembly, and the structure of FIG. 39 illustrating the connection of the extension assembly to the structure.

FIG. 41 is a perspective of the solar array of FIG. 20 installed on a structure.

FIG. 42 is a perspective of a portion of the solar array and the structure of FIG. 41 illustrating the extension assembly for spacing the solar modules of the solar array beyond an eave of a roof of the structure.

FIG. 43 is an underside perspective of the solar array of FIGS. 41 and 42.

FIG. 44 is an underside view of an example 2-PV panel awning including solar modules attached to each other in an end to end arrangement.

### DETAILED DESCRIPTION

Example solar arrays of this disclosure include a pre-engineered and pre-assembled solar awning including a collection of solar modules that are positionable. For example, the solar modules are collapsible to a stowed position that is safe for travel and facilitates the solar modules being attached to a structure at a location (e.g., a factory) and the structure shipped to a final destination with the solar modules attached to the structure.

Embodiments of this disclosure address issues currently preventing solar technology from being adopted by the factory-built structure industry. For example, the solar array provides an easy to install and safe to ship product that does not require any changes to the existing factory-built construction practices. As a result, installers for factory-built structures do not need specialized training or experience with solar technologies.

Embodiments of installation methods of this disclosure enable a low skilled and fast installation of a solar array for the producer of factory-built structures that will not slow down the assembly line and will not increase the cost of other structures being constructed on the same assembly line. In addition, a pivot feature of a solar awning of the disclosures allows the awning to be placed in a safe transportation position to ensure the structure and awning can be shipped to a location without being damaged. At the final site of the structure, the installation team can easily rotate the awning from a first “stow” position to a second “deployed” position within minutes without training, tools, or additional skills.

Solar arrays examples include a pre-engineered solar awning that can be pre-manufactured and delivered as a completed modular unit. Multiple units can be installed together to create a continuous solar awning. Waterproofing mechanisms within and between units can be deployed to provide a waterproof covering to protect users at entry points into the structure. In addition, since the units are pre-assembled, all solar specific skills traditionally associated with solar installations are removed from the awnings installation and the awning is installable on the structure by typical trades and current manufacturing labor.

In addition, example solar arrays can be pre-assembled for fast and easy installation to a side or wall of a structure during the manufacturing process rather than on a rooftop. In addition, since the solar array is installed on the side of the structure, the solar array does not disturb the waterproofing nor the warranty of the roof covering (such as asphalt shingles) and reduces the risk of roof leaks and warranty claims. Also, roofs of factory-built structures are often built to the limit of allowable load and thus cannot accommodate additional load from solar panels. The roofs of factory-built structures typically include structural members that are not sized to accommodate attachment of the solar panels and resist pull-out stresses. However, the walls include structural members (e.g., studs) that have excess capacity since the spacing between the structural members is controlled by the requirements of the siding outside the structure and drywall on the inside which require closer spacing than would be dictated by loads on the wall. In addition, the structural members of the wall are typically larger in size than the structural members of the roof are better able to accommodate attachment of the solar panels and resist pull-out stresses than the structural members of the roof. Therefore, a solar array attachable to a wall of the structure can take advantage of the extra load capacity of the wall and be installed without modifications to the existing structure.

Example solar arrays can provide solar power options for power consumers that are unable to afford site-built structures or conventional solar options because the solar arrays can be less expensive than conventional solar options and/or the solar arrays can be installed on existing or new structures including factory-built structures in an economical manner. Accordingly, the solar arrays can provide increased access to solar power options for a larger range of the population than other solar options.

Further objects and advantages of this disclosure will become apparent from a consideration of the drawings and description.

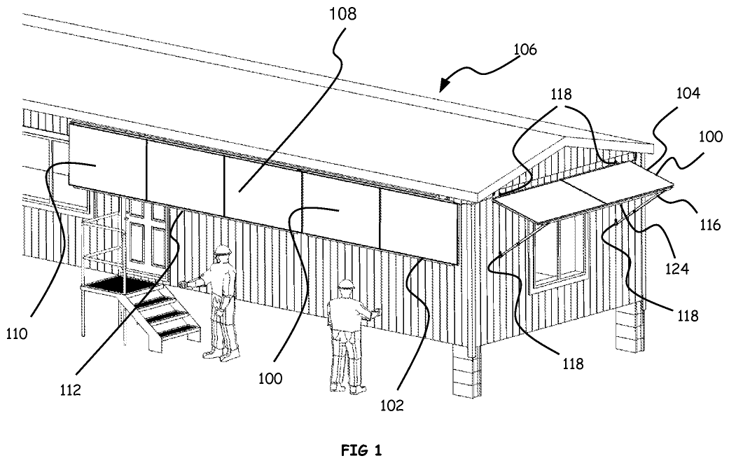

Referring now to FIGS. 1-4, views of an example structure 106 and a solar array are shown. The example solar array is intended to be installed on a wall of a building or structure such as a factory-built structure, e.g., a manufactured home, and can function, for example, as an awning. The structure 106 may include one or more walls having a top and a bottom and extending at least in part vertically. In addition, the structure 106 may include a roof that is at least partly supported by the walls and extends horizontally and non-parallel to the wall.

In an example, the structure 106 is a factory-built structure. As used herein, the phrases “factory-built”, “factory-built structure” or “factory-built component” refer to a structure or component that is assembled at least partly at a manufacturing site and is capable of being shipped to an off-site location for installation or use. In some embodiments, the structure 106 may be a single-story or multiple-story residence or a commercial building and may be assembled or built on-site. In some embodiments, the structure 106 may include some components that are fabricated or assembled at an off-site location (e.g., prefab components) and shipped to the installation site and assembled to form the structure 106. In some embodiments, the solar array can be attached to any man-made or natural structure and is configured to act as a sub-structure.

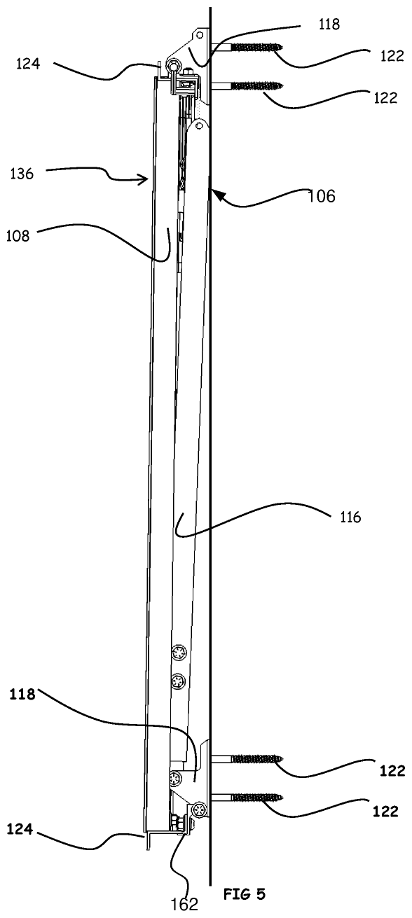

The solar array includes solar or photovoltaic (PV) modules 108 (shown in FIG. 5) that are arranged to form awnings 100, 110. The phrases “solar module” and “PV module” are used interchangeably in the disclosure. In the example, each solar module includes a frame and a photovoltaic (PV) laminate. The laminate includes a plurality of PV cells encapsulated in an active layer between a front cover (facing the sun) and a back cover (underside). The laminate may further include wiring (not shown) connecting the PV cells in a series and/or parallel configuration. In some embodiments, the solar modules are frameless and/or do not include glass panels covering the PV cells. The awnings 100, 110 each include one or more solar modules 108. In the example, the awnings 100, 110 each include two or more solar modules 108 that are arranged in a side-by-side configuration. The awnings 100, 110 may include a gasket 136 extending along and/or between the solar modules 108.

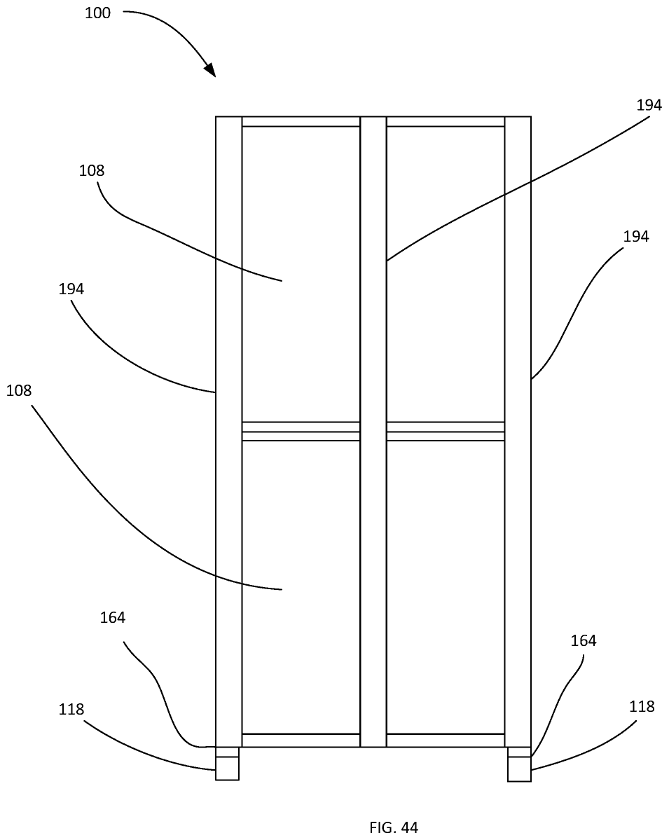

In addition, the solar array includes wall mounts 118 to attach the awnings 100, 110 to the wall of the structure 106 between the top and the bottom of the wall. The solar array can be installed on any side of the structure 106, as shown in FIG. 1. An example of the solar array includes at least two configurations, a 2-PV panel awning 100, and a 3-PV panel awning 110. In the examples shown in FIG. 1, the solar modules 108 are positioned side-by-side along the wall of the structure 106 such that each solar module has an end positioned adjacent to the structure 106. Also, FIG. 44 illustrates an example of the 2-PV panel awning 100 including solar modules 108 arranged in an end-to-end configuration. In the example shown in FIG. 44, a first solar module 108 is positioned adjacent the structure 106 and a second solar module 108 is spaced from the structure 106 by the length of the first solar module 108. In some embodiments, the second solar module 108 may be positionable relative to the first solar module 108 to facilitate the solar array switching between the stowed and deployed configuration. In other embodiments, the solar array may include any number of solar modules arranged in any suitable manner.

In the example, the awnings 100, 110 are movable relative to the structure 106 between a first position and a second position when the wall mounts 118 are attached to the structure 106 and the awnings 100, 110 are attached to the wall mounts 118. For example, the awnings 100, 110 are stowed adjacent the wall of the structure 106 when the solar array is in the first position. The awnings 100, 110 extend outward from the wall of the structure 106 when the solar array is in the second position.

Any number of awnings made up of any number of solar modules 108 can be installed to create as many arrays as required. FIG. 1 shows an awning 100 including two solar modules 108 in the stow position 102 and attached to the structure 106 on a long side of the structure 106. Also, an awning 110 including three solar modules 108 is attached to the structure 106 on the long side of the structure 106 adjacent to the panel awning 100 including two solar modules 108 and is in the stow position 112. An awning 100 including two solar modules 108 is attached to the structure 106 on an end of the structure 106 and is in a deployed position.

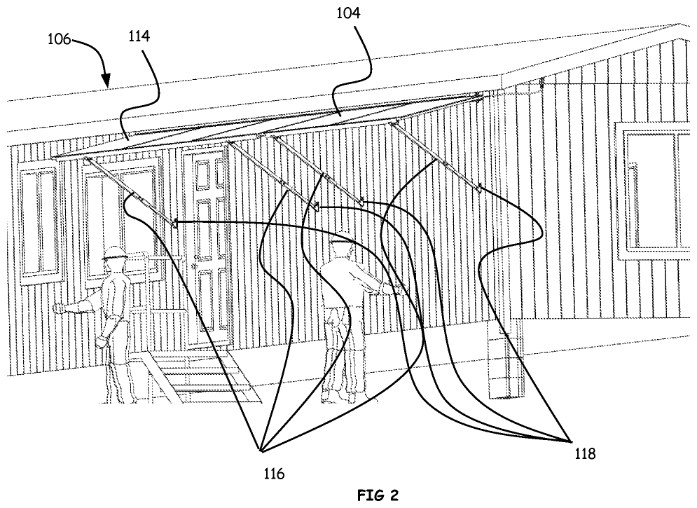

When in the deployed position, the awnings 100, 110 are supported by supports, e.g., telescoping support struts 116. In the example, two telescoping support struts 116 are utilized by each awning 100, 110 in the deployed position 104, 114 as shown in FIGS. 1 and 2. For example, when the solar module is in the second position, the telescoping support struts 116 extend at least partly along an extension of the solar module away from the wall of the structure 106 and at least partly in a vertical direction. The telescoping support struts 116 are adjustable to facilitate multiple distances and angles between the solar module and the wall. However, other embodiments could incorporate any number of telescoping support struts 116. In some embodiments, the telescoping support strut 116 could be non-telescoping and have a fixed length and/or be a single component.

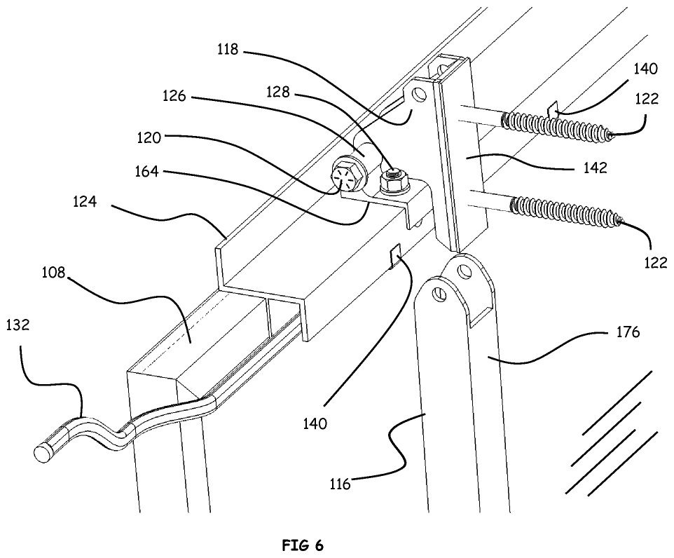

As shown in FIGS. 4 and 5, in the example, the telescoping support struts 116 are secured to the structure 106 by wall mounts 118. The wall mounts 118 are spaced apart from each other and are arranged to secure to supporting members of the wall such as wall studs or other framing members. The wall mounts 118 can include a waterproofing seal or water-resistant mechanism such as a flashing 142. For example, the flashing 142 could be a tape that extends along a mounting face of the wall mounts 118 as shown in FIGS. 6, 7, 8A, & 8B. The flashing 142 seals penetrations (e.g., attachment points) or interfaces between components (the wall mounts 118 and the wall) to prevent water intrusion and/or to redirect moisture toward a drainage system.

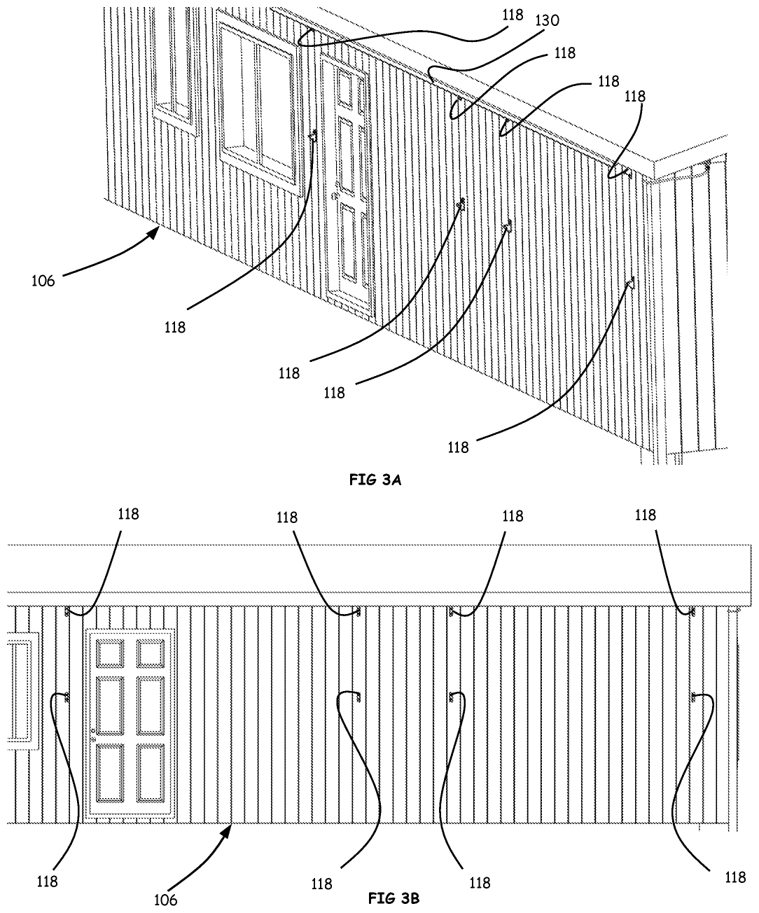

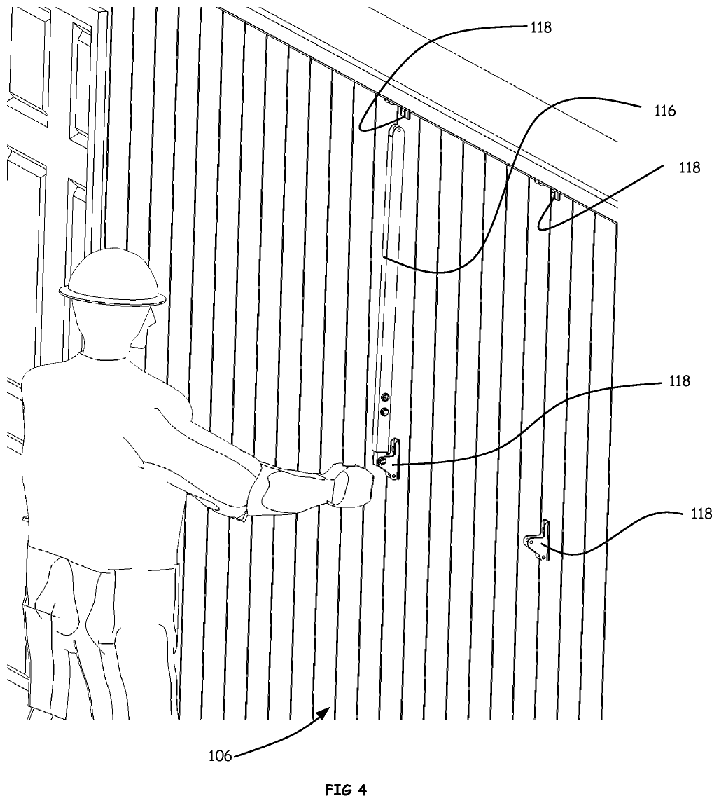

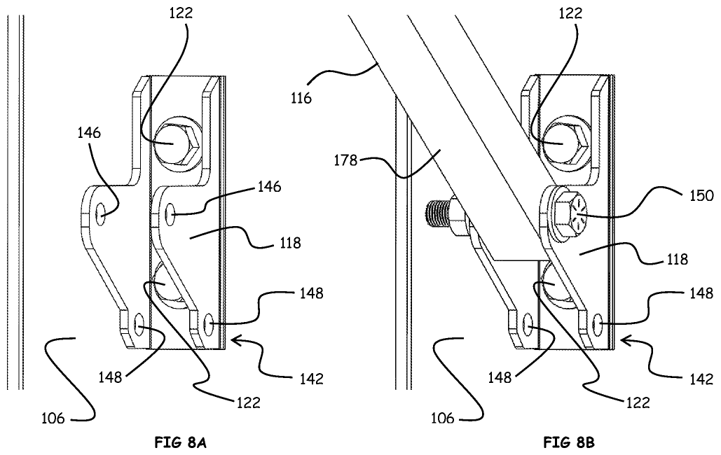

In addition, the side of the awning 100, 110 closest to the structure 106 is also connected to the structure 106 by wall mounts 118. In the example, the bottom and top wall mounts 118 are directly above each other as shown in FIGS. 3A & 3B. In other embodiments, the wall mounts 118 are not directly above each other. The wall mounts 118 are secured to the structure 106 by attachment devices such as anchor bolts 122, as shown in FIG. 8A or 8B, or by any other suitable mechanism. In the example, the top and bottom wall mounts 118 are the same. In other embodiments, the top and bottom wall mounts 118 may be different. The wall mounts 118 can be of any shape and have any number of fasteners or anchor bolts 122 required to secure the awning 100 or the telescoping support strut 116 to the side of the structure 106.

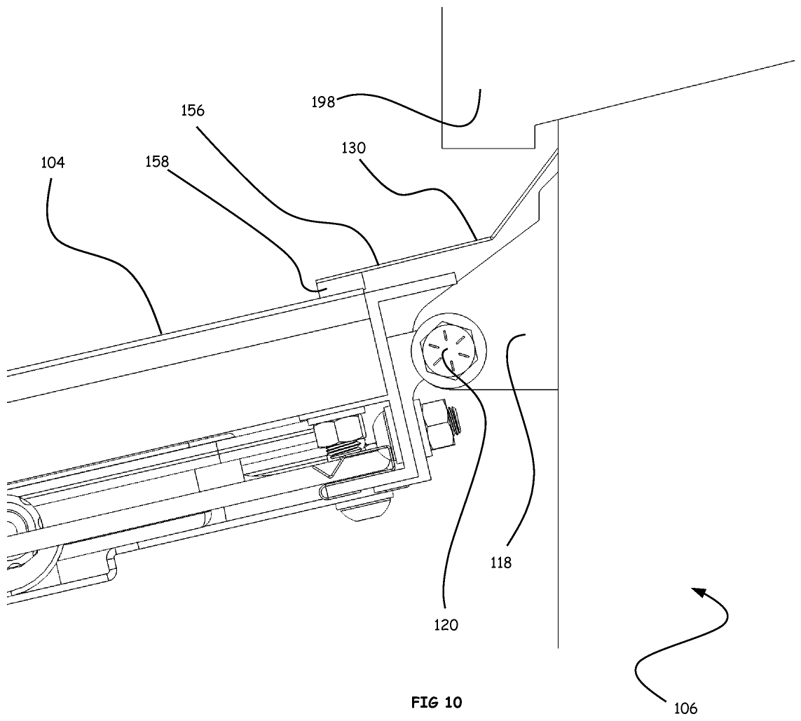

FIG. 10 is a side view of a portion of the structure 106 with the solar module 108 in the installed position and illustrating a wall flashing assembly 130 at an interface of the structure 106 and the solar module 108. In the example, the wall flashing assembly 130 includes wall flashing 156 and a gasket 158. The wall flashing 156 may be metal, plastic, or any other suitable material and extends across the interface. The gasket 158 is a flexible material that seals and prevents water intrusion. In other embodiments, the wall flashing assembly 130 may include tape or any other suitable components.

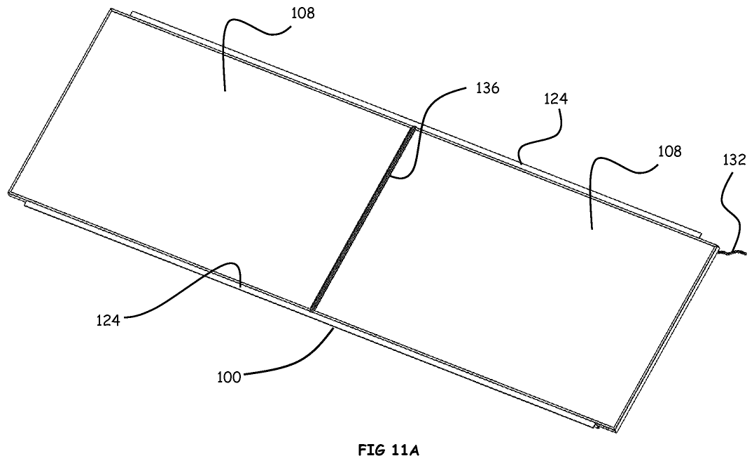

The top side of the 2-panel awning 100 is shown in FIG. 11A and the back side is shown in FIG. 11B. The top side is arranged to face the sun and receive sunlight for powering the solar modules 108. The awning 100 can be attached to the structure on-site or at another location. The 2-panel awning 100 consists of two solar modules 108 attached to two rails 124 by PV panel connections 160. The connections 160 may include attachment devices such as bolts or any other suitable mechanisms. Rail bracket assemblies 162 are attached to the rails 124 and configured for strut connections. Rail bracket assemblies 164 are attached to the rails 124 and configured for wall connections. In some embodiments, the rail bracket assemblies 162, 164 are the same bracket but are installed differently to the rail 124, and in other embodiments the rail bracket assemblies 162, 164 are different brackets. The hardware for connecting the rail bracket assemblies 162, 164 to the strut and the wall can be preinstalled to the rail bracket assemblies 162, 164 such that the person attaching the awning 100 to the structure 106 does not need to find additional hardware during installation. As a result, the rail bracket assemblies 162, 164 save time and ensure all components are available at the time of installation.

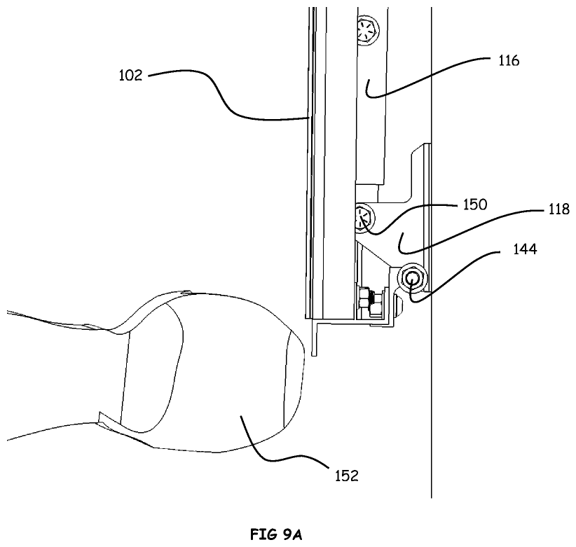

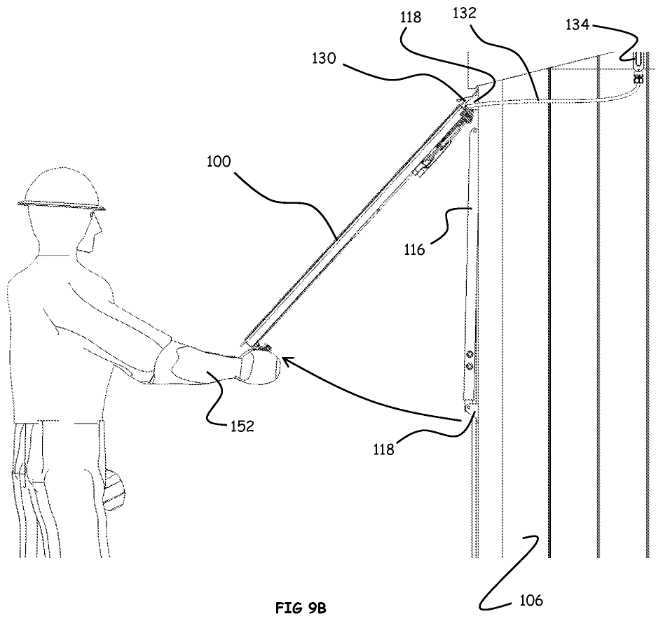

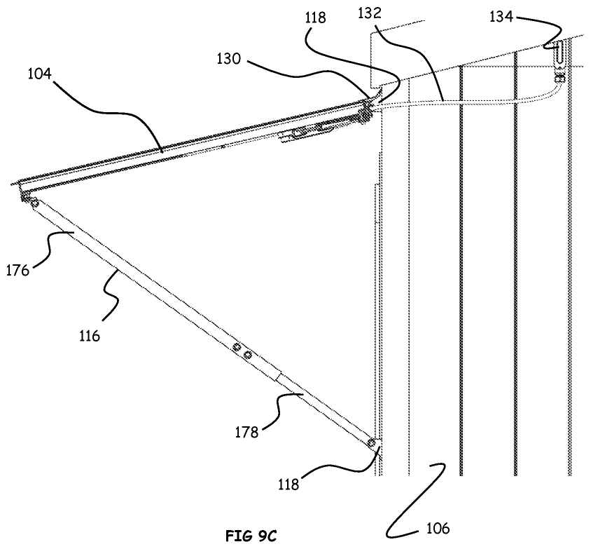

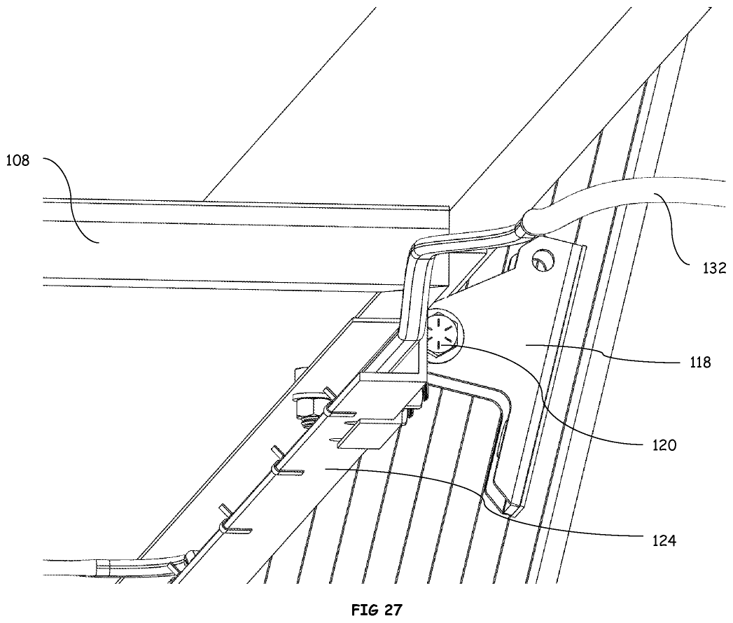

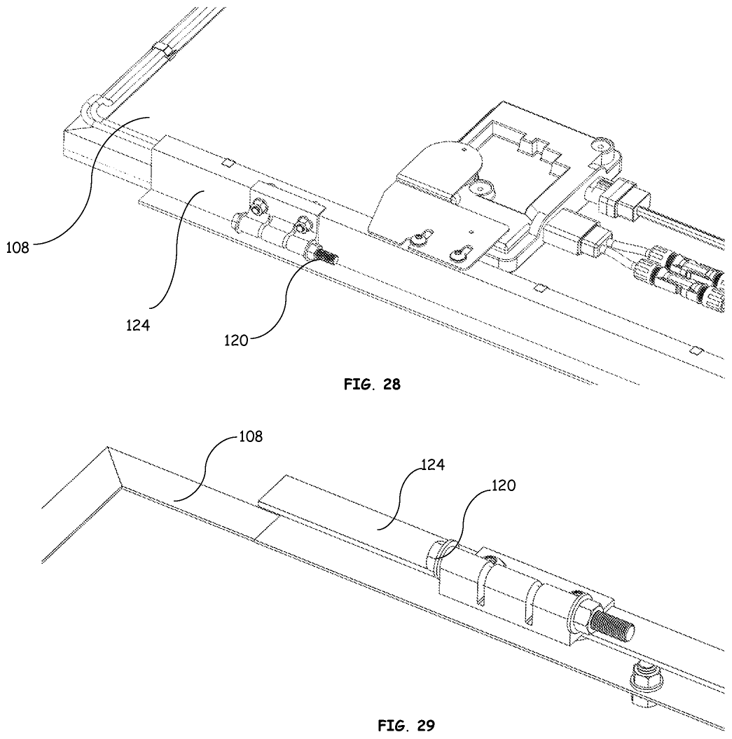

The awning 100 shown in FIG. 11B also includes preinstalled power electronics 166 such as a microinverter or DC power optimizer. The power electronics 166 are wired together by power cables 132 with extra wire for connecting to either another solar module 108 or awning 100 or to wiring through a junction box 134 as shown in FIG. 9C. In addition, as shown for example in FIGS. 27 and 28, cables for the awning 100 are managed by wire clips 140 or by some other wire management feature. The power electronics include at least one connection point for connecting to power electronics on the structure 106.

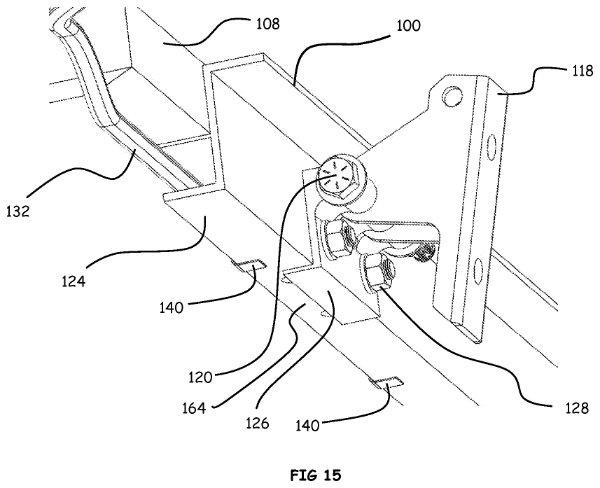

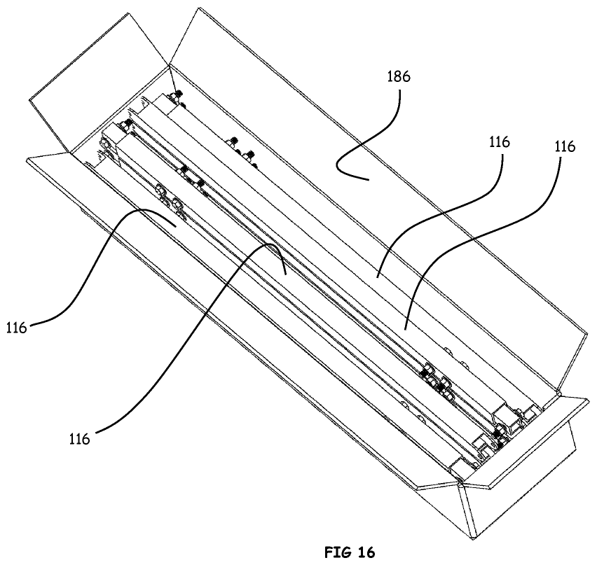

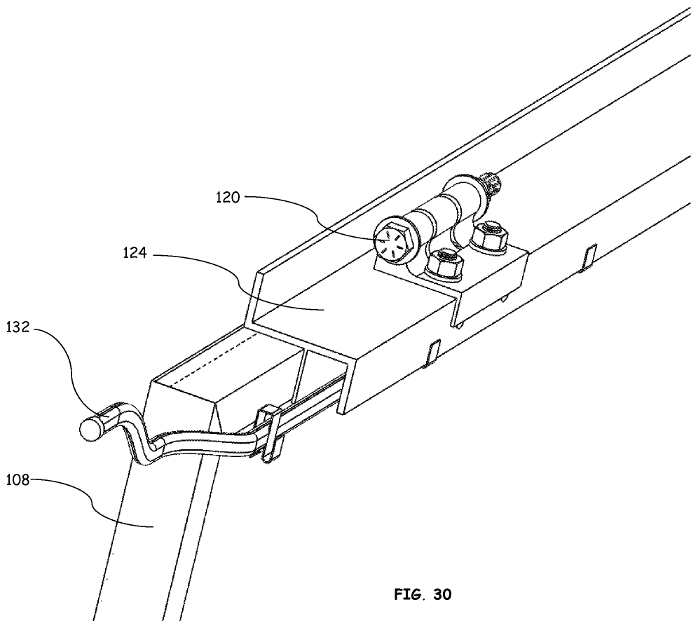

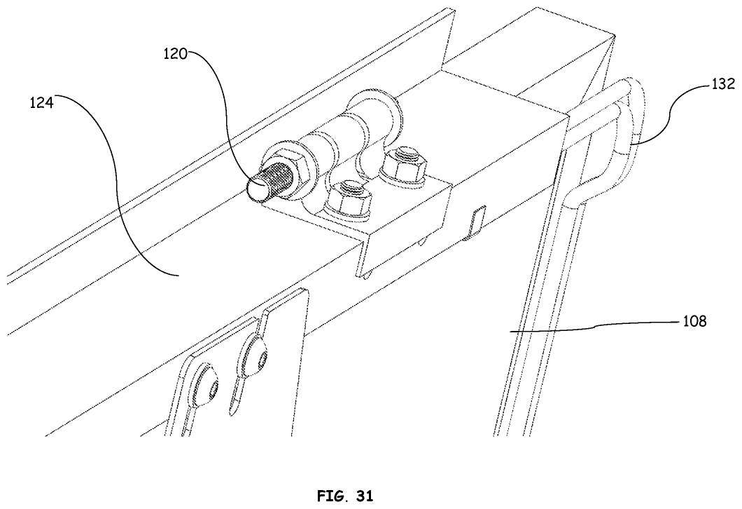

The awning 100 is connected to the wall of the structure 106 by securing the rail brackets 126 to the upper wall mounts 118 and forming a pivot connection 120 as shown in FIG. 15. The awning 100 is free to rotate, e.g., unbiased, around the pivot connection 120 such that gravity would cause the awning 100 to orient vertical, as shown in FIG. 5. For example, the pivot connection 120 between the upper wall mounts 118 and the rail brackets 126 forms a hinge that allows rotation of the awning 100 about an axis extending through the hinge, as shown in FIGS. 5 and 29-31. For example, the solar module 108 includes a first end and a second end and is pivotable about the hinge between the first position and the second position such that at least one of the first end and the second end of the solar module 108 pivots relative to the structure. In the example, the solar module includes a free first end that moves upward away from the wall of the structure 106 when the solar module switches from the first position to the second position. The solar module moves downward toward the wall to transition from the second position to the first position. In other embodiments, the solar array includes one or more bias mechanisms such as springs or pneumatic actuators that bias the awnings 100, 110 toward the deployed or stowed positions.

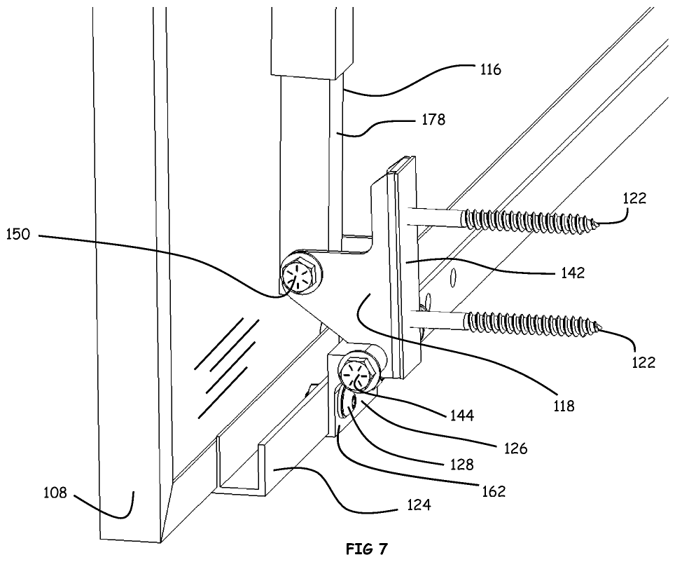

To secure the bottom of the awning 100 as shown in FIG. 7, the rail bracket 126 is secured to the stow hole 148, FIG. 8A, of the bottom wall mount 118 by hardware such as stow connection 144. In other embodiments, the connection could be a pin connection or snap fit or any other mechanism that allows the rail bracket 126 to be secured to the wall mount 118. The rail brackets 126 are secured to the rails 124 by attachment devices, e.g., bolts or fasteners, 128.

The telescoping support strut 116 connects to the bottom wall mount 118 at the strut holes 146, as shown in FIGS. 8A and 8B and forms a strut pivot connection 150. In the example, the telescoping support strut 116 is secured to the bottom wall mount 118 by an attachment device such as a bolt extending through the strut holes 146. In other embodiments, the telescoping support strut 116 is secured to the bottom wall mount 118 by pins, a snap-fit connection, or some other means.

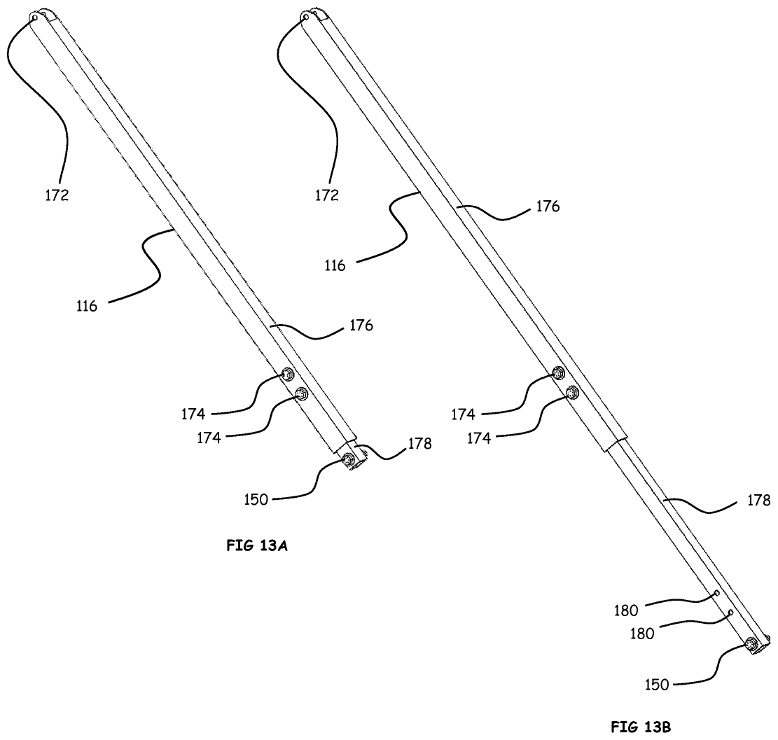

As shown in FIGS. 13A and 13B, in the example, the telescoping support strut 116 has an inner tube 178 and an outer tube 176. The inner tube 178 slides inside the outer tube 176. For example, the two tubes are connected through a telescoping connection 174. In the example, the telescoping connection 174 is achieved using an attachment device such as a bolted connection. The inner tube 178 and the outer tube 176 have holes 180 positioned at various locations to receive the attachment device or bolt and secure the telescoping support strut 116 in a desired position. For example, the inner tube 178 has holes 180 adjacent to a free end of the inner tube 178 that is not positioned in the outer tube. The holes 180 are arranged to secure the telescoping support strut 116 in one or more collapsed positions. As shown in FIG. 13A, the outer tube 176 receives and extends along substantially the entire length of the inner tube 178 in a collapsed position. The inner tube 178 also has holes 180 located at an opposite end for securing the telescoping support strut 116 in one or more positions. In other embodiments, pins, spring pins or spring plungers, or some other connections can be used to secure the telescoping support strut 116 in position. In the example, the inner tube 178 connects to the bottom wall mount 118, as shown in FIGS. 7, 8B, 9C.

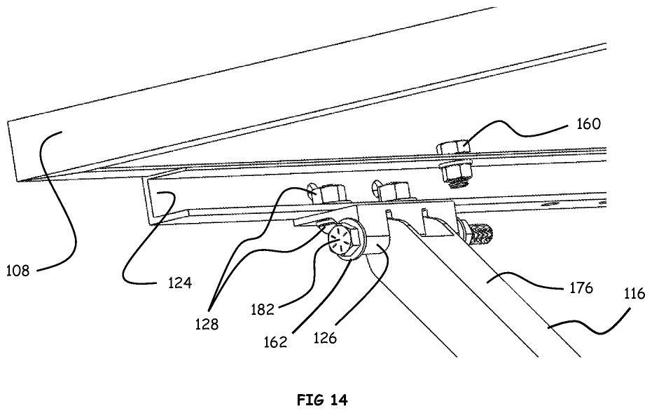

As shown in FIGS. 9C, 13B, and 14, the outer tube 176 of the telescoping support strut 116 connects to the rail brackets 126 configured for the strut connection on the awning 100. For example, an attachment device such as a bolt 182 extends through the strut to connection hole 172 of the outer tube 176. The outer tube 176 is positionable to position the awning 100 into a deployed position 104 (shown in FIG. 9C). The telescoping support strut 116 can utilize several telescoping connections 174 (shown in FIG. 13A, 13B) to allow for any number of angles for the deployed position 104. For example, an orientation of the solar module relative to the wall of the structure 106 is adjustable by adjusting the position of the telescoping connections 174 to change the angle defined by the solar module and the wall. In embodiments, the awning 100 extends at an angle relative to the wall in a range of 1° to 180°, or in a range of 45° to 90°. In a stowed position, the awning 100 extends along the wall at an angle relative to the wall in a range of 0° to 10°.

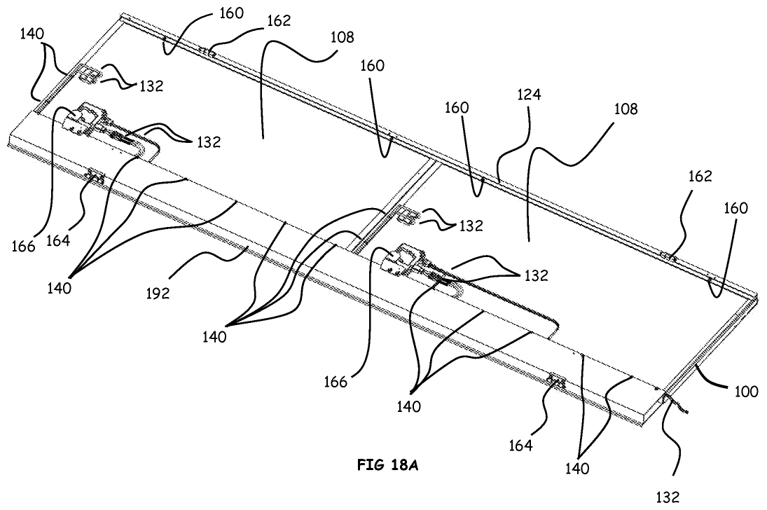

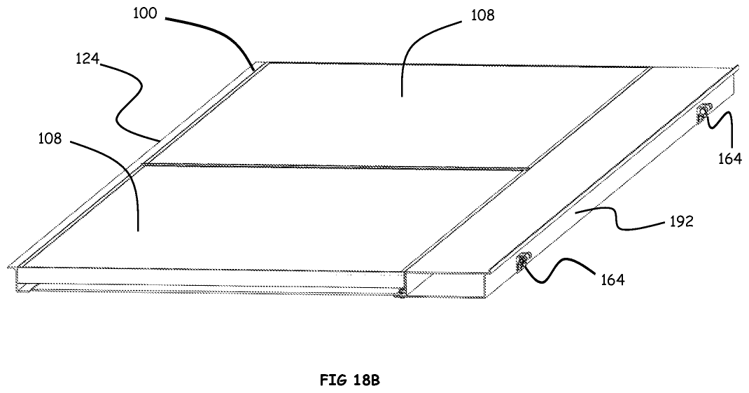

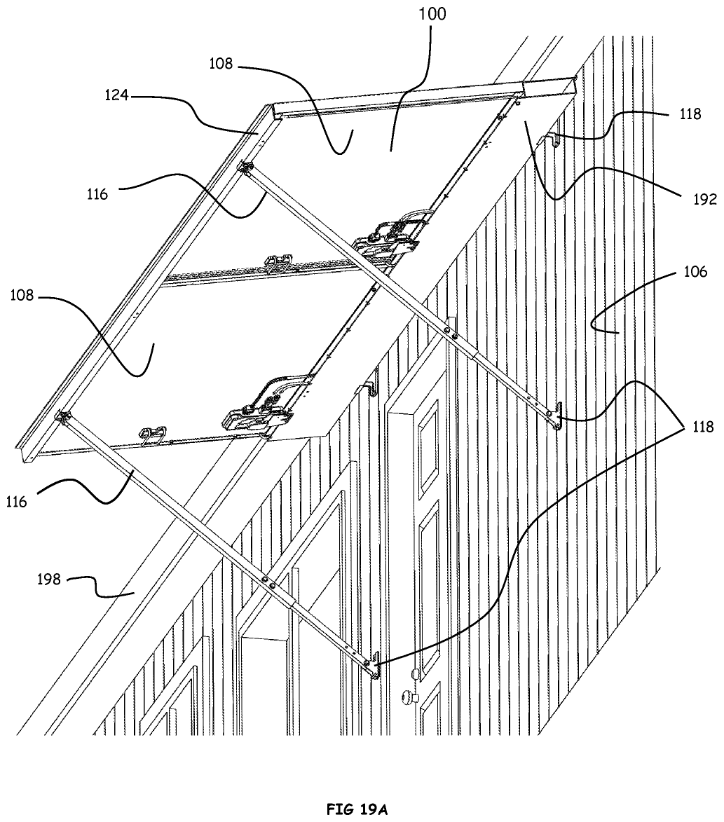

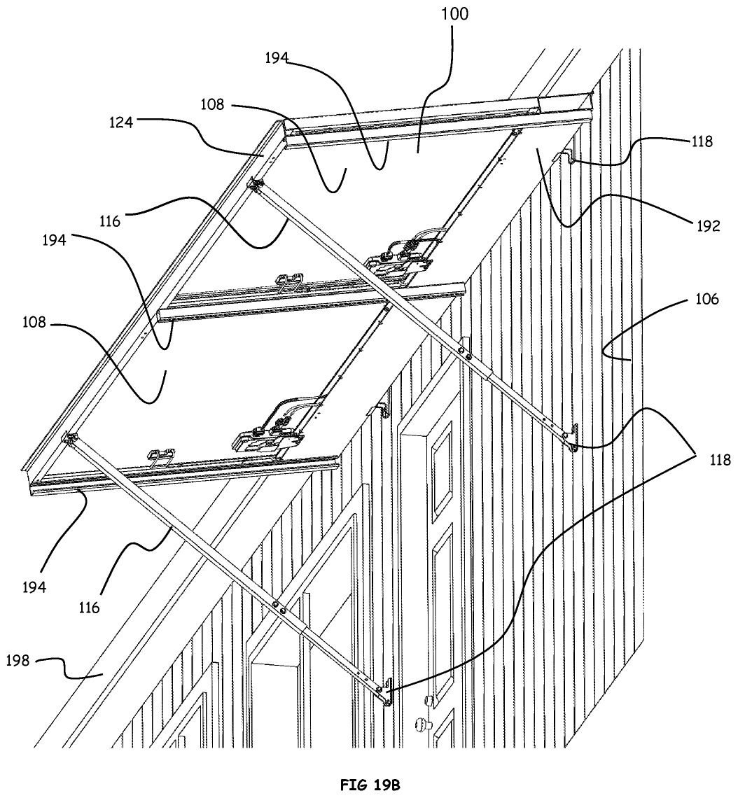

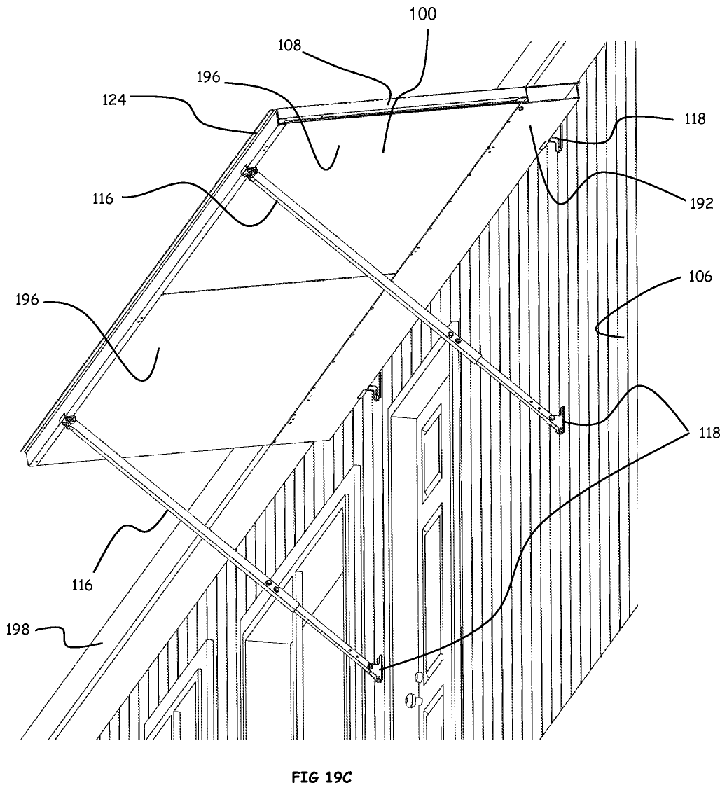

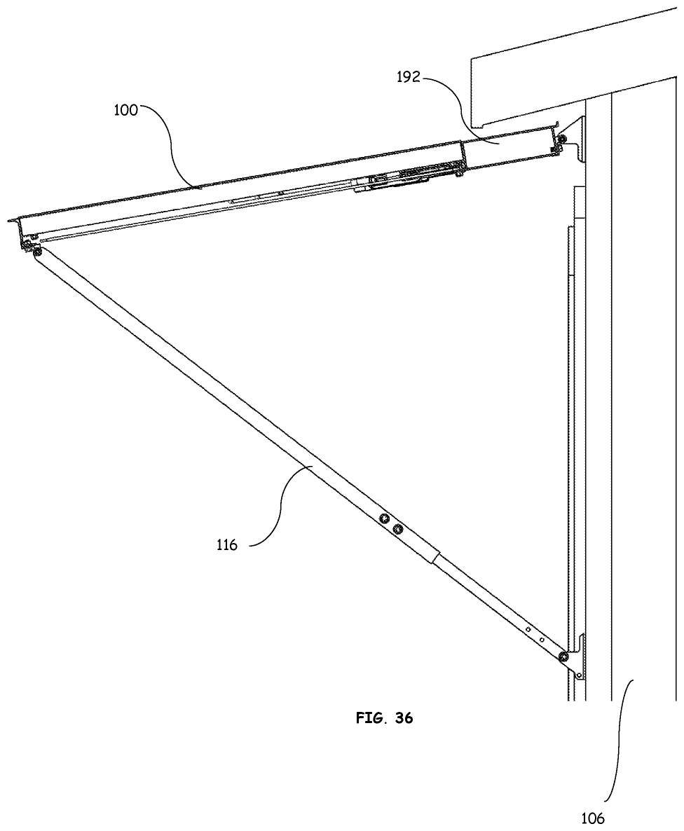

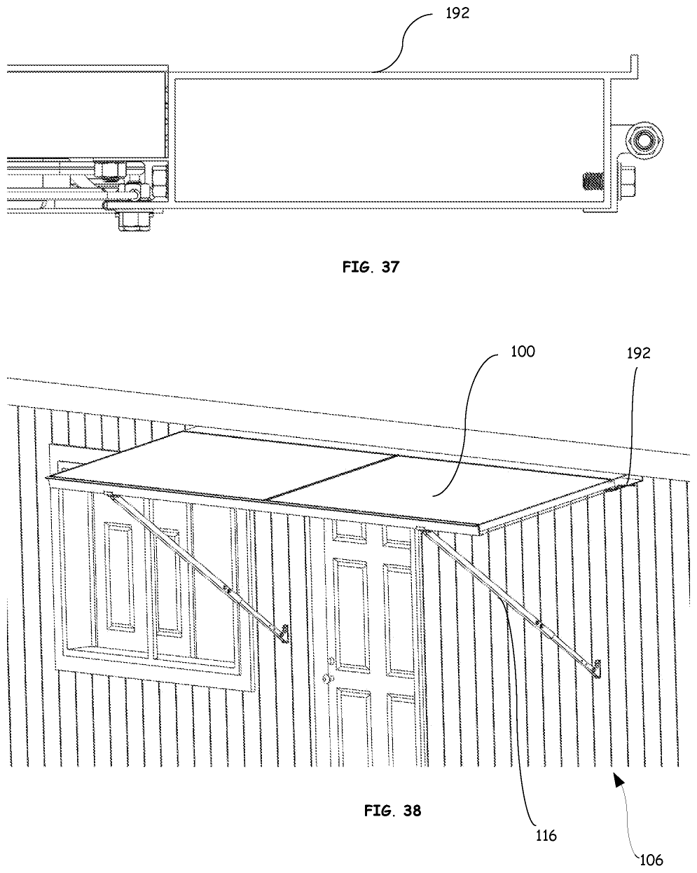

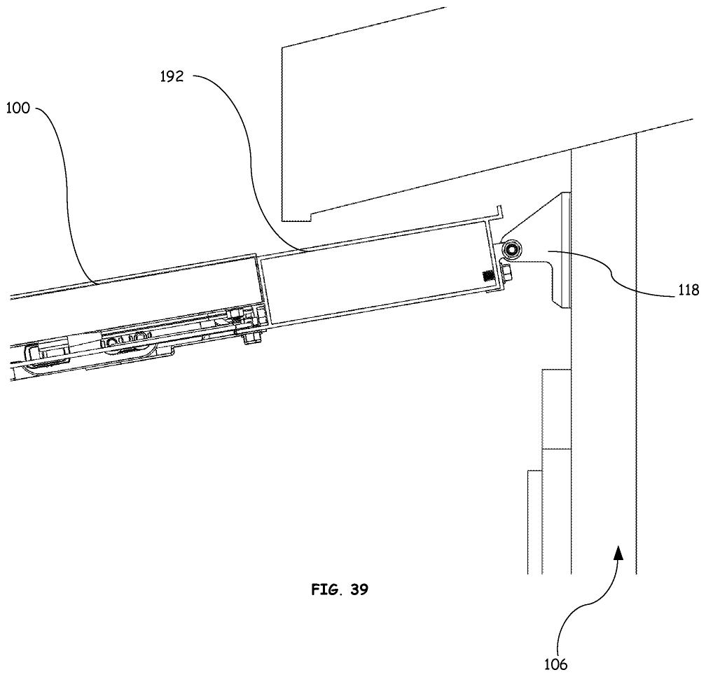

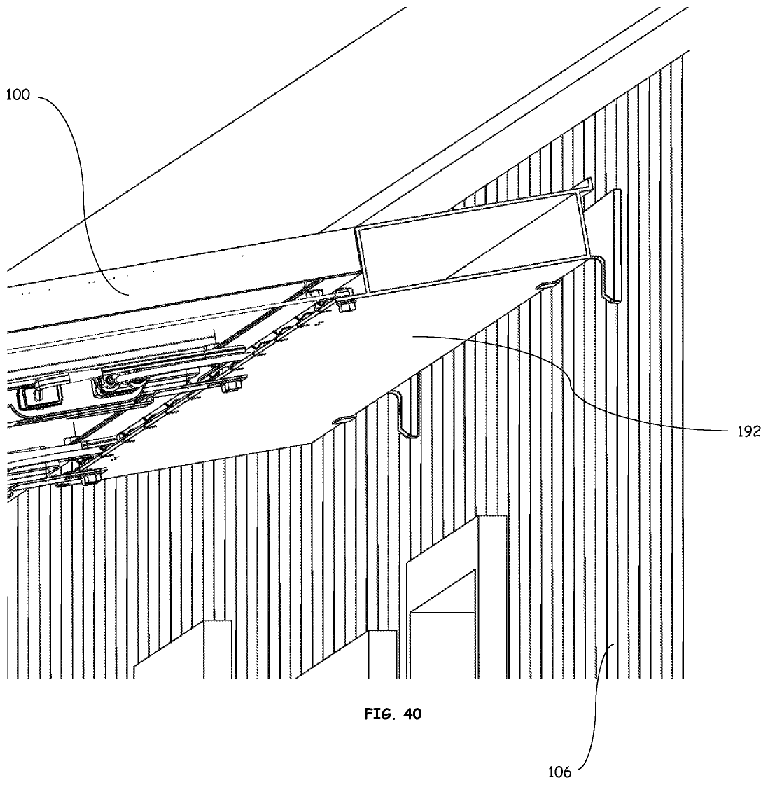

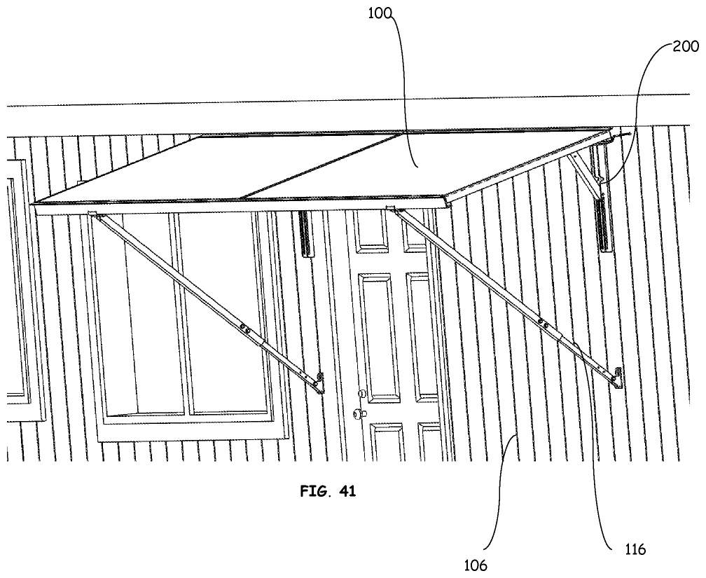

Solar modules 108 need access to sunlight to generate electricity. An eave 198 or other components of the structure or other objects could produce shadows on the modules 108 resulting in power loss. Thus, in an example shown in FIGS. 18-19A and 36-40, the solar array includes an extended rail 192 and the 2-PV panel awning 100 is designed to extend beyond the eave 198 of a roof of the structure 106. The extended rail 192 is shown in FIG. 18A-19C and is sized to space the modules 108 away from obstructions such as eaves 198 on the structure 106. In the example, the extended rail 192 includes a hollow rectangular section as shown in FIG. 18B that is roughly equivalent to the length of the eave 198 as shown in FIG. 19A. In other embodiments, other shapes can be used to locate the solar modules 108 and the rail bracket assemblies 164 configured for wall connection. In addition, various spacing can be used to support the solar modules 108 further from the wall of the structure 106 and prevent shading or improve water shedding.

Referring to FIG. 19B, a support structure 194 can be used to increase the structural strength of the awning 100. For example, the support structure 194 provides additional support when the solar module 108 is coupled with an extended rail 192 and the solar module 108 is spaced a distance away from the structure 106. The support structure 194 is a rail or beam that is attached to the extended rail 192 and/or the PV module 108. The support structure 194 supports a span of the PV module 108 and extends to or beyond an end of the PV module 108, as shown in FIG. 19B. In the example shown in FIG. 19B, the support structure 194 extends mid-span of the awning along edges of the pair of the solar modules 108 and at a location between the two side support structures 194. In the example shown in FIG. 44, the support structures 194 extend along the sides and middles of the solar modules 108 and are at least as long as the cumulative length of the solar modules 108 when the solar modules 108 are positioned end to end. Accordingly, the support structures 194 provide increased support to the solar modules 108 and facilitate the solar modules 108 having greater spans and/or being spaced a greater distance from the structure 106. In other embodiments, the solar array may include any support structures 194. For example, the solar array may include a plurality of support structures arranged in any manner on the solar modules.

In another embodiment shown in FIG. 19C, covers 196 can be used to protect the bottom side of the PV module 108 and hide the junction boxes 134, power cables 132, power electronics 166, wire clips 140, and all other fasteners and components. In the example, the solar array includes two of the covers 196. In another embodiment, the solar array includes only one cover 196 that spans the entire underside of the awning 100. In another embodiment the cover 196 only covers a portion of the underside or covers only certain components.

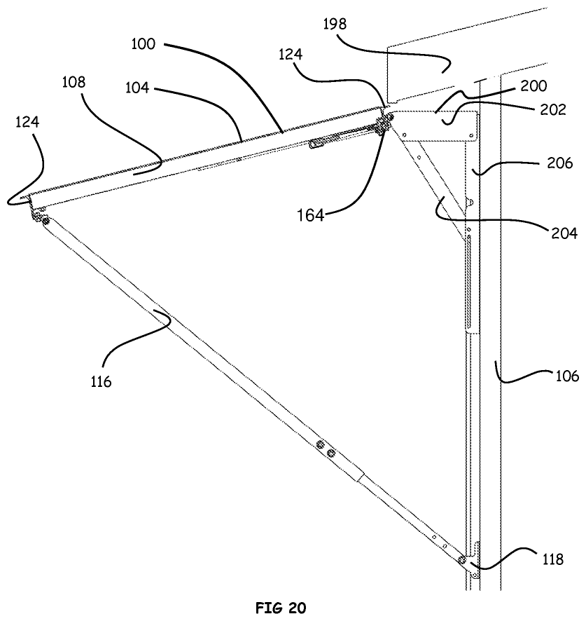

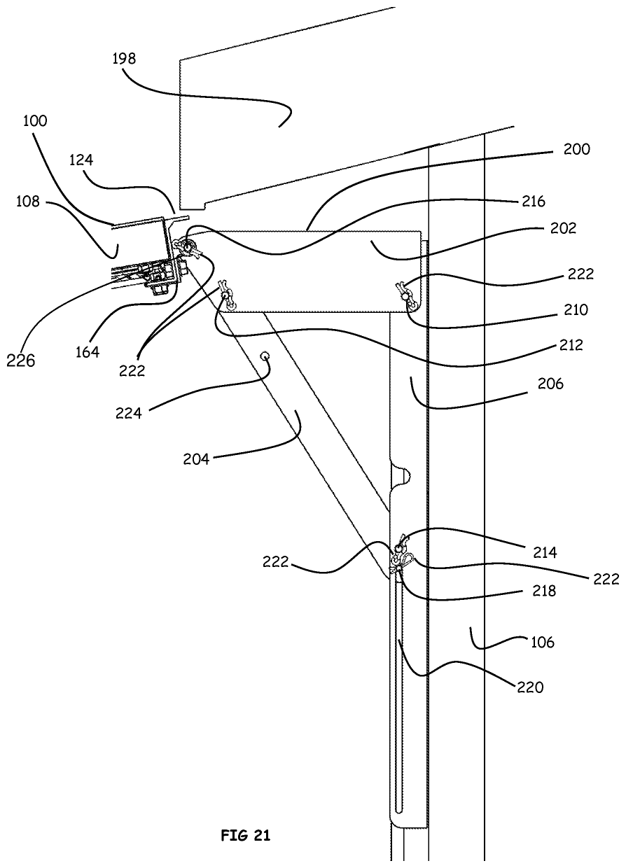

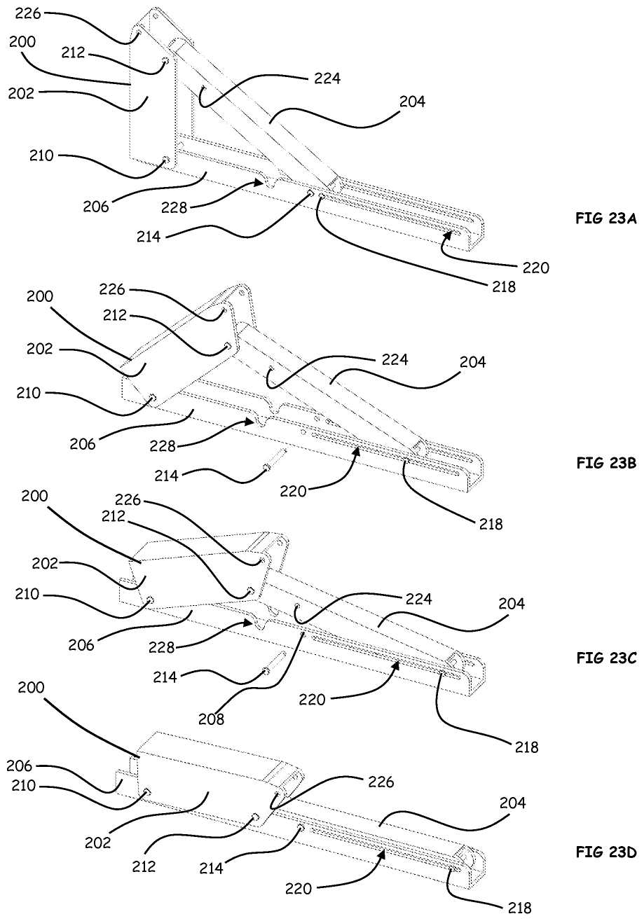

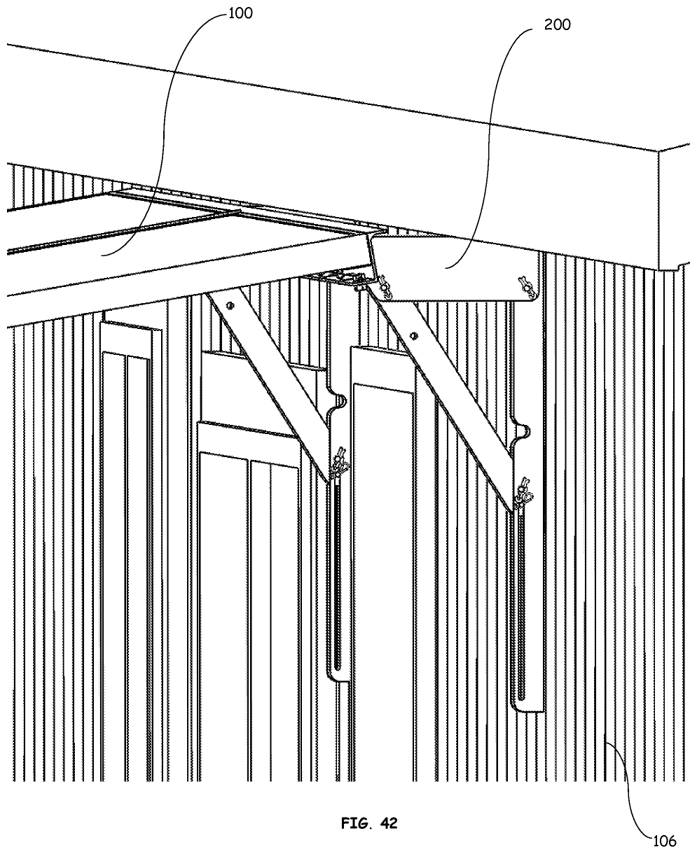

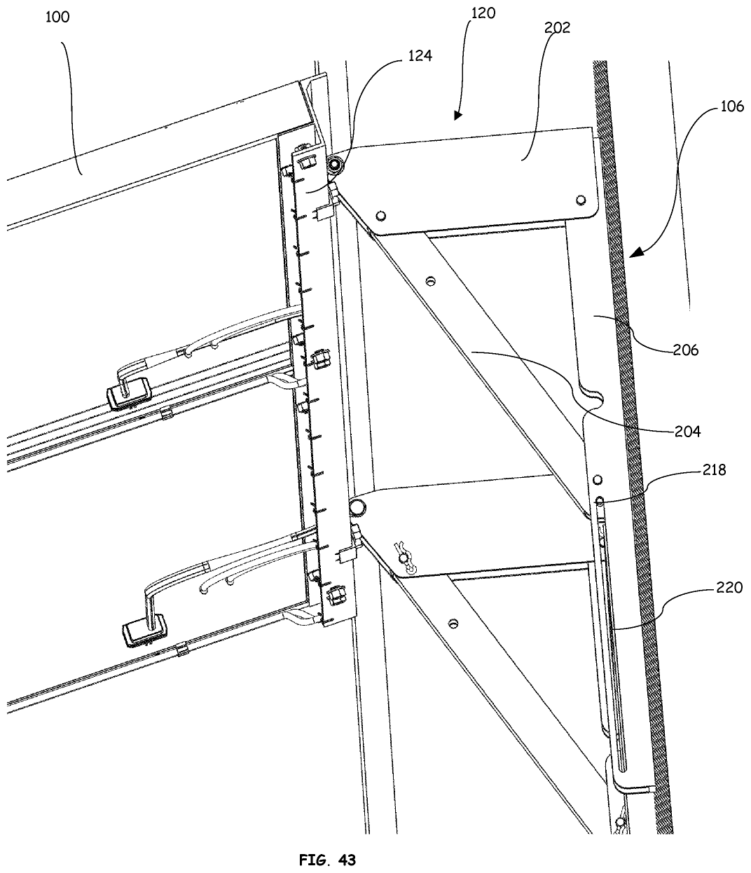

Referring to FIGS. 20-24B and 41-43, in another embodiment, the solar modules 108, are located away from the wall of the structure 106 by a 3-bar linkage design such as a wall mount extension assembly 200. For example, the 3-bar linkage design includes three bars that are attached at links and define a triangular shape. The wall mount extension assembly 200 positions the awning 100 out from under the eave 198 without requiring a special rail such as the extended rail 192 shown in FIGS. 19A-19C. The rail bracket assembly 164 (shown in FIG. 21) is secured to the hole 226 (shown in FIGS. 23A-23D) at the top strut 202 of the wall mount extension assembly 200 by the rail pin 216. The top pin 210 is used to secure the top strut 202 to the extended wall mount 206. The support strut 204 is connected to the extended wall mount 206 by the wall mount lock pin 214. A cotter pin 222 or other device can secure the pins 210, 214 within a hole. A cover 196 (shown in FIG. 19C) can be deployed on either side of the wall mount extension assembly 200 to provide a better aesthetic and/or add structural stiffness to the assembly. In other embodiments, any number of the components of the wall mount extension assembly 200 can be fixed and not allowed to rotate in relation to each other.

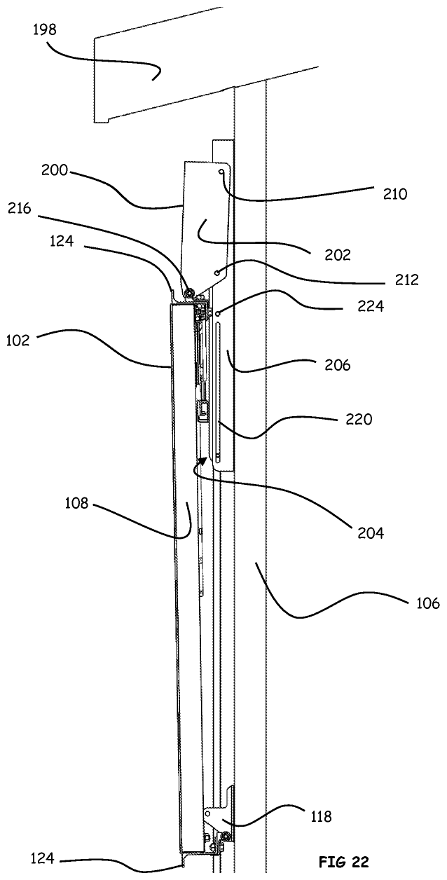

To facilitate a transition from deployed to stowed position, the extended wall mount 206 of the wall mount extension assembly 200 includes a slot 220. The support strut 204 is connected to the slot 220 by slide pin 218. The slide pin 218 is free to move within the slot 220. The support strut 204 is locked into a first position (e.g., a deployed position) by the wall mount lock pin 214 as shown in FIGS. 21 and 23A. Once the wall mount lock pin 214 is removed, the bottom of the support strut 204 is free to move down the slot 220 of the extended wall mount 206. FIG. 23B shows the support strut slid down the slot 220 and the wall mount extension assembly 200 in a second position. FIG. 23C shows the wall mount extension assembly 200 in a third position and transitioning into a fourth position (e.g., a stow position) from the first position. FIG. 23D shows the wall mount extension assembly 200 in a locked stow position where the wall mount lock pin 214 is inserted into the wall mount lock pin hole 208 and the stow lock hole 224 of the support strut 204. The extended wall mount 206 includes a relief 228 that allows the full collapse of the wall mount extension assembly 200 by allowing the extension pin 212 that connects the support strut 204 to the top strut 202 to not interfere with the extended wall mount 206. The support strut 204 nests inside the extended wall mount 206 which nests inside the top strut 202. FIG. 22 shows the entirety of the wall mount extension assembly 200 in the stow position.

In another embodiment, the components of the wall mount extension assembly 200 do not nest within each other. In another embodiment, the components do not collapse but stay fixed. For example, the awning 100 can be switched between the stored and deployed positions when the awning 100 is removed, the wall mount extension assembly 200 is removed, and/or some of other components are removed and/or added. In some embodiments, the awning 100 pivots between the deployed and stowed positions and the wall mount extension assembly 200 stays fixed in position.

In other embodiments, the pin connections can be bolted by any attachment device that keeps the components secured to each other and still allows the mating components to function as described.

In other embodiments, the 3-bar linkage could be a 4-bar linkage or any other mechanism that allows the awning 100 to move from a stow position in which the awning 100 extends along and adjacent to the structure 106 toward a deployed position in which the awning 100 extends out from under the eave 198 of the structure 106.

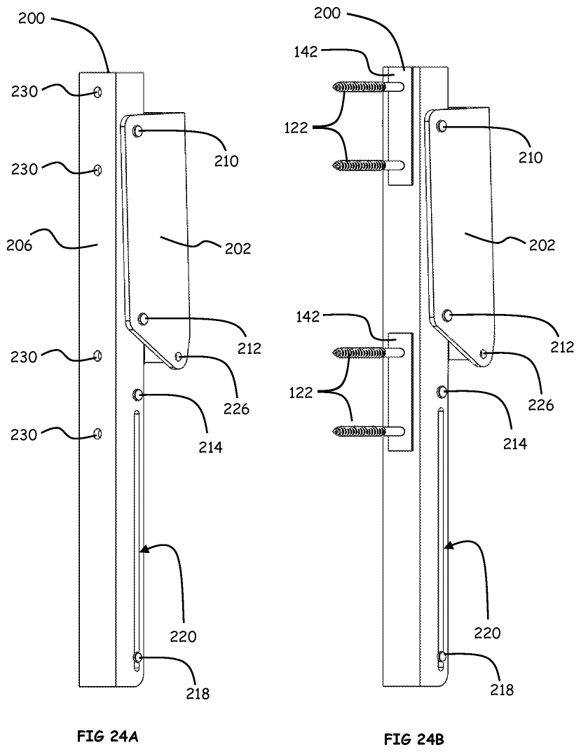

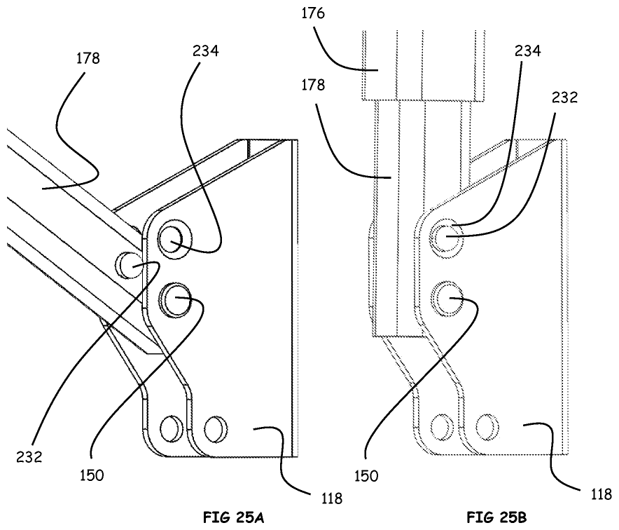

FIG. 24A shows the wall mount extension assembly 200 attached to the structure 106 (shown in FIG. 1) in a collapsed position suitable for shipping. FIG. 24B shows the wall mount extension assembly 200 in a factory-built configuration with attachment devices to attach to the side of the structure 106. The factory-built configuration includes anchor bolts 122 that pass through the holes 230 as shown in FIG. 24A and may attach, for example, to structural members of a wall of the structure 106. In other embodiments, any number of anchor bolts 122 and/or other type of fastening mechanism can be used to secure the wall mount extension assembly 200 to the structure.

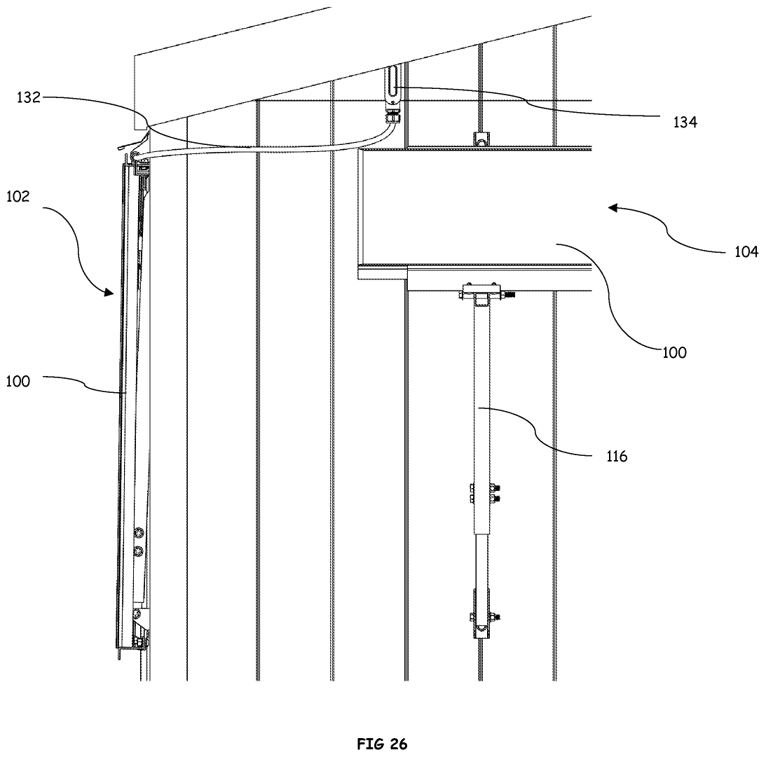

FIG. 25A shows another embodiment of the bottom wall mount 118 that includes a strut stow hole 234 with a telescoping support strut 116 in the installed position. The telescoping support strut 116 includes a push button on the spring pin 232. When the telescoping support strut 116 is placed in the stow position as shown in FIG. 25B, the push button on the spring pin 232 is depressed to allow the spring pin 232 to pass behind the wall of the wall mount 118 until the spring pin 232 springs out into the strut stow hole 234. The spring pin 232 in the strut stow hole 234 acts as a locking mechanism that fixes the telescoping support strut 116 in a position where the telescoping support strut 116 will not come into contact with either the wall of the structure 106 or the back of the solar module 108 when the awning 100 is in the stow position which could otherwise result in damage to either surface. In other embodiments, the locking function is performed by a pin, fastener, or other mechanism. In other embodiments, instead of a locking mechanism, the telescoping support strut 116 has a removable cover with soft surfaces that may be flexible and fit around the telescoping support strut 116 to protect the adjacent surfaces including but not limited to the wall of the structure 106 and the back side of the PV module 108 when the awning 100 is in the stow position. In other embodiments, the cover is not removable.

In other embodiments, the telescoping support strut 116 is removed to allow for the awning 100 to be put in the stow position without the telescoping support strut 116 being able to damage either the back of the PV module 108 or the wall of the structure 106.

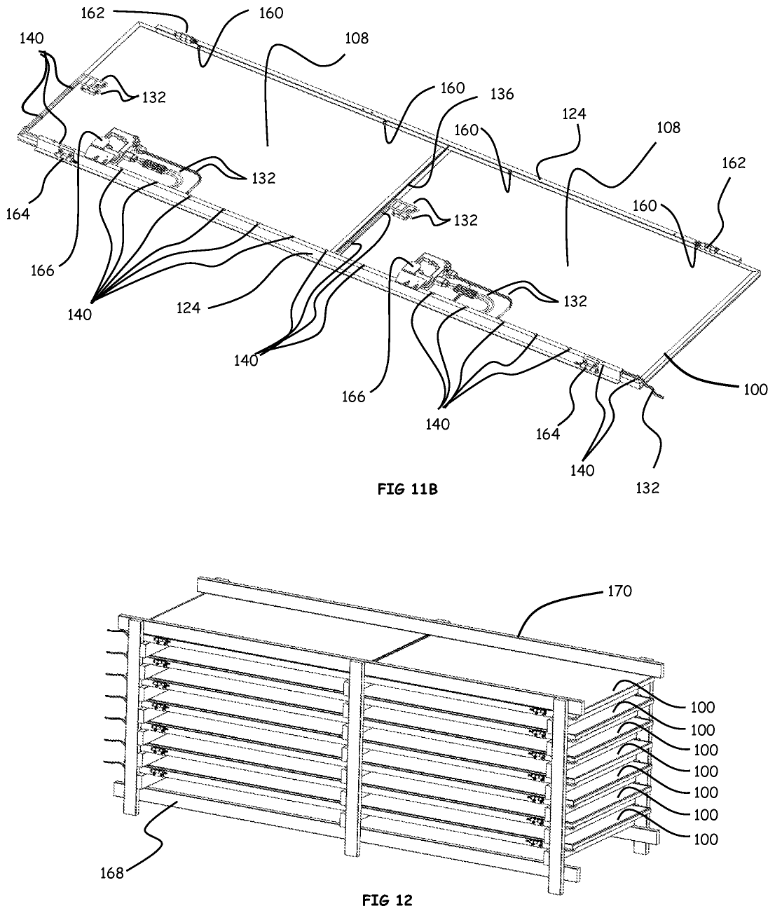

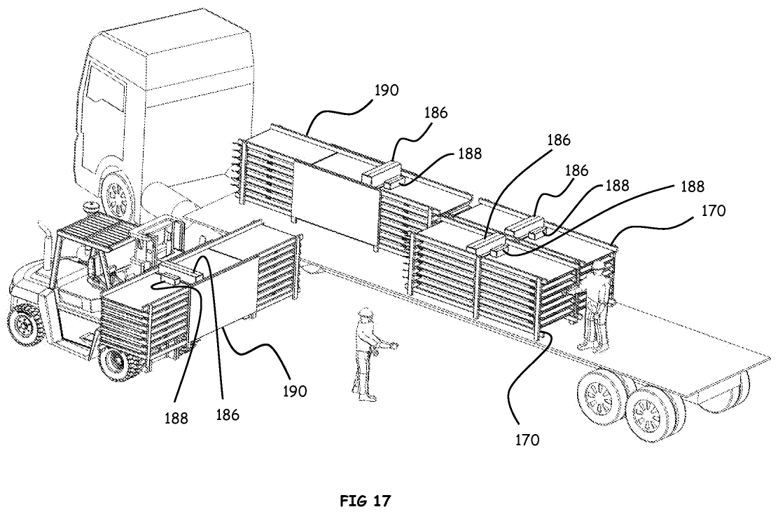

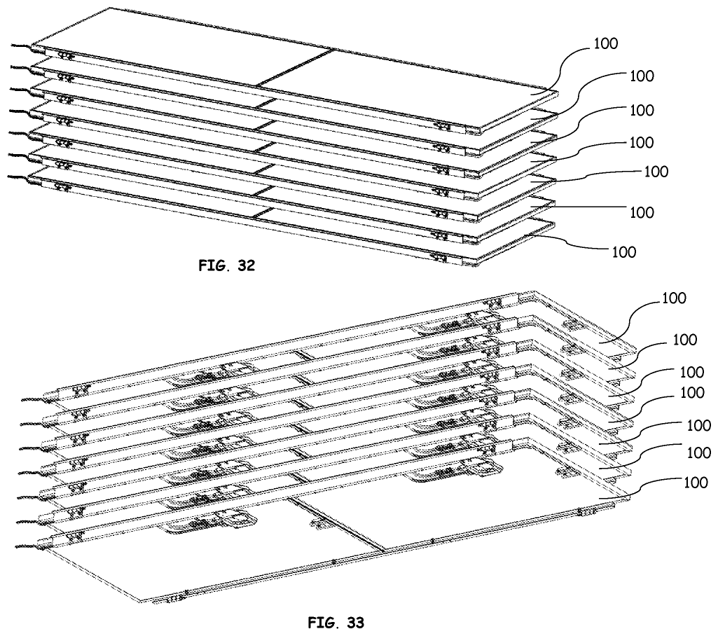

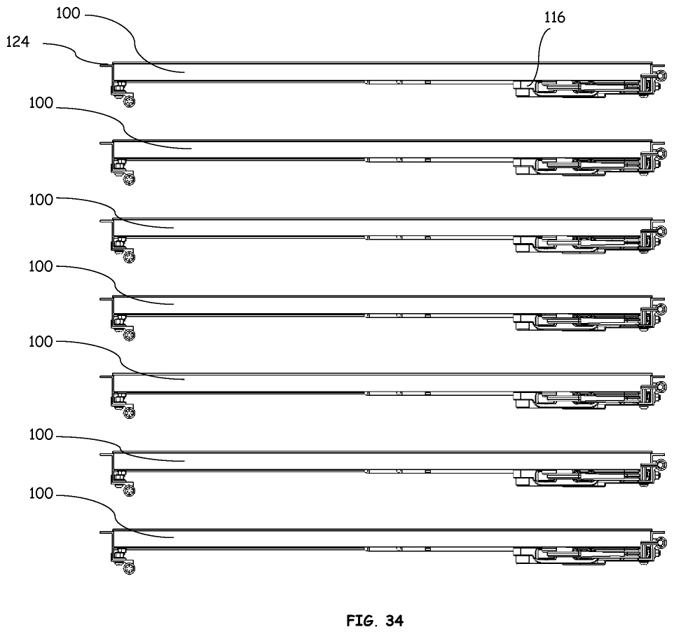

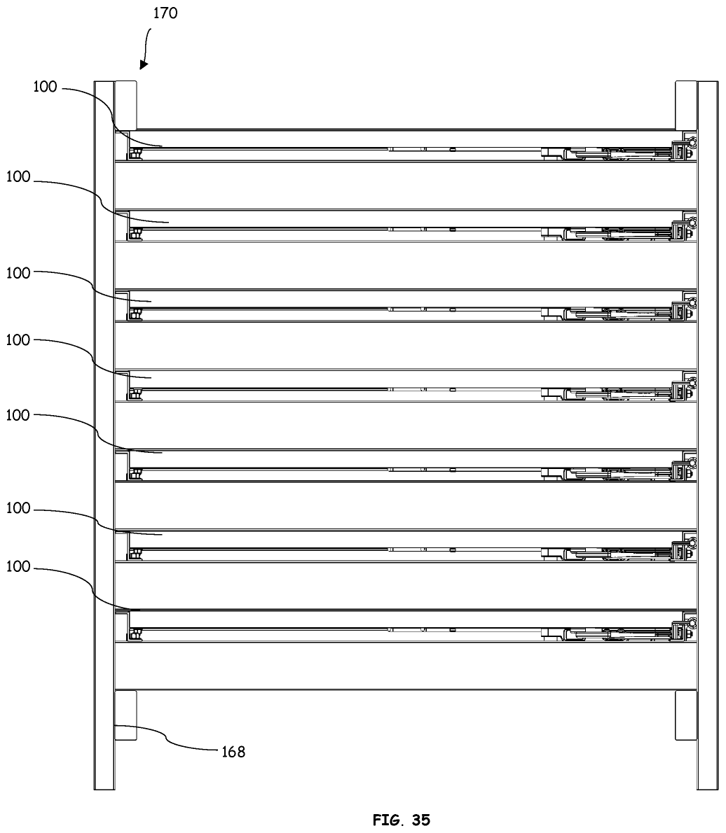

Referring to FIGS. 12 and 32-35, an awning 100, 110 can be shipped to a site as a single unit, or awnings 100 can be stacked in a shipping crate 168 to form a shipping unit 170, 190. The shipping crates 168 are sized to receive the awnings 100, 110 in a factory-built configuration such that the awnings 100, 110 can be removed from the shipping crates 168 and are immediately ready for installation without adjustment or assembly. In the example, the shipping unit 170 includes 2-panel awnings 110 and the shipping unit 190 includes 3-panel awnings 100. In addition, the shipping units 170, 190 each include packages 186 of telescoping support struts and packages 188 of wall mounts. Each package 186, 188 defines an interior space sized and shaped to receive, for example, telescoping support struts and/or wall mounts in a factory-built configuration and ready for install. FIG. 17 shows the packages 186, 188 placed on top of the shipping unit 170 to form a kit including the awnings 100, 110, packages 186 of telescoping support struts, and packages 188 of wall mounts. By including all the components that the installer would need to install the awnings 100, 110 to the structure, the number of ordered stock keeping units (SKUs) is reduced and all the components required to install the awning are factory-built in the most useful arrangement and ready to install.

Referring to FIGS. 1-5, during installation, the wall mounts 118 are secured to the structure by anchor bolts 122 that are inserted through openings in the wall mounts and into structural members such as wall studs. The wall mounts 118 are secured at locations that correspond to locations of the structural members and are determined to provide support for the solar array. For example, the spacing between adjacent wall mounts 118 may correspond to a multiple of the spacing between structural members.

After the wall mounts 118 are installed to the wall, the telescoping support struts 116 are installed on the wall mounts 118 as shown in FIG. 4 such that the telescoping support struts 116 rest against the wall. The awning 100 is then hung from the top wall mounts 118 and secured to the bottom wall mounts 118 as shown in FIG. 5 to secure the awning 100 the awning in the stow position 102. In the example, the wall mounts 118 and the rail bracket assemblies 164 are connected by a stow connection 144 (shown in FIG. 7) which acts as locking mechanisms to secure the modules 108 of the awning 100 in the stow position. The telescoping support struts 116 are captured behind the awning 100 and the system is ready for travel, as shown by the modules on the long side of the structure in FIG. 1. The installer may electrically connect the awnings 100, 110 to the wiring as shown in FIG. 9C. In other embodiments, any of the installation steps may be performed at other locations.

Once a structure arrives at a final destination, the rail bracket assembly 162 that is configured for strut connection is released from the stow connection 144 from the bottom wall mount 118, as shown in FIG. 9A. After the bottom of the awning 100 is free, the operator 152 lifts the awning 100 and pivots the awning 100 on the pivot connection 120 with the top side of the awning 100 connected to the top wall mount 118. The operator then extends the telescoping support strut 116 to an installation length as shown in FIG. 13B and connects the telescoping support strut 116 to the rail bracket assembly 162 that is configured for strut connection and places the awning 100 into a deployed position as shown in FIG. 9C. The process is repeated for the other struts of the awning 100 and for each module or awning.

In one embodiment, the awning 100 can be transitioned from the stowed position to the deployed position without a tool. In other embodiments, the solar array can include a spring loaded mechanism, an actuator, or similar mechanism that automates the transition between the stowed and deployed positions.

In other embodiments, the telescoping support struts 116 can be installed to the lower wall mount 118 after the structure 106 is delivered and while the awnings 100, 110 are being erected to the deployed positions.

The wall mount extension assembly 200 installs in the same manner as the wall mount 118. However, additional attachment devices may be used to increase the attachment strength of the wall mount extension assembly 200 to the structure 106.

Solar arrays of this disclosure include solar modules that are attachable to structures such as factory-built or site-built structures and are positionable relative to the structures. For example, the solar arrays include one or more solar modules that are attachable to a structure and are positionable between a first position and a second position. The solar modules can be attached to a wall of the structure instead of a roof of the structure. Accordingly, the solar modules can be attached to a wider range of structures without exceeding load or code limits and the solar modules do not affect the waterproofing of the roof. In addition, each solar module is stowed adjacent the wall of the structure when the module is in the first position, and the module extends outward from the wall when the module is in the second position. As a result, the solar arrays can be modular structures that are easily attached to the structure without specialized skills and that will not slow down an assembly process of the structure. In addition, the solar arrays can be attached to a factory-built structure that is assembled at a first location and shipped to a second location. For example, the module can be attached to the factory-built structure at the first location and placed in the stored position for shipping. The module can be switched to the deployed position at the second location. Alternatively, the solar module is attached to the structure at the second location. As a result, the solar modules do not slow down the assembly line process for the factory-built structures and can provide less expensive solar power options for purchasers of factory-built structures.

The solar arrays of this disclosure can be provided in a kit that includes all necessary components to install the solar array on a structure at any location (e.g., a factory location or an installation location), for either factory-built structures, site-built structures, or natural structures.

The solar arrays of this disclosure can reduce the cost of installing solar arrays at a factory, or alternatively at a site. In addition, the solar arrays can reduce installation errors made by personnel attempting to assemble and install complex solar arrays at an installation site. Moreover, the solar arrays of this disclosure can reduce the number of penetrations and waterproofing that are required for installation of the solar arrays to structures because the solar arrays are installed on a wall of the structure and not on a roof.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A solar array attachable to a structure, the structure including a wall having a top and a bottom and extending at least in part vertically, the solar array comprising:
a solar module; and
a mount to attach the solar module to the wall of the structure between the top and the bottom of the wall,
the solar module movable relative to the structure between a first position and a second position when the mount is attached to the structure,
the solar module stowed adjacent the wall of the structure when the solar module is in the first position, and
the solar module extending outward from the wall when the solar module is in the second position.

2. The solar array of claim 1, further comprising rails attached to the mount, the solar module is attached to the rails.

3. The solar array of claim 2, further comprising one or more brackets that attach the rails to the mount.

4. The solar array of claim 1, wherein the solar module includes a first end and a second end, wherein the mount includes a hinge, and wherein the solar module is pivotable about the hinge between the first position and the second position such that at least one of the first end and the second end of the solar module pivots relative to the structure.

5. The solar array of claim 4, wherein the mount is attached near the first end of the solar module and the second end of the solar module pivots relative to the structure.

6. The solar array of claim 1, wherein, in the first position, the solar module is positioned along the wall and extends at an angle relative to the wall in a range of 0° to 10°.

7. The solar array of claim 6, wherein, in the second position, the solar module extends at an angle relative to the wall in a range of 1° to 180°.

8. The solar array of claim 7, wherein the angle is in a range of 45° to 90°.

9. The solar array of claim 7, wherein, in the second position, an orientation of the solar module relative to the wall is adjustable to change the angle of the solar module and the wall.

10. The solar array of claim 1, further comprising a lock to secure the solar module in the first position.

11. The solar array of claim 1, further comprising one or more struts that extend at least partly along an extension of the solar module away from the wall when the solar module is in the second position, and the one or more struts are adjustable to change a distance between the solar module and the wall.

12. The solar array of claim 11, wherein the one or more struts do not need to be removed from the solar module to switch the solar module between the first position and the second position.

13. The solar array of claim 1, further comprising a flashing to seal the mount or attachment points on the structure.

14. A kit comprising:
the solar array of claim 1;
attachment devices to attach the mount to the wall of the structure; and
a shipping unit that receives the solar array and the attachment devices in a factory-built configuration.

15-18. (canceled)

19. A factory-built structure that is assembled at a first location and shipped to a second location, the factory-built structure comprising:
a wall;
a solar module; and
a mount attached to the solar module and the wall, the solar module movable relative to the factory-built structure between a first position and a second position,
the solar module stowed adjacent to the wall of the factory-built structure when the solar module is in the first position, and
the solar module extending outward from the wall when the solar module is in the second position.

20. The factory-built structure of claim 19, further comprising a roof defining an eave, the solar module positioned to extend beyond the eave.

21. The factory-built structure of claim 20, further comprising an extended rail attached to the solar module and the mount and sized to space the solar module away from the wall and beyond the eave.

22. The factory-built structure of claim 20, wherein the mount is sized and shaped to space the solar module away from the wall and beyond the eave.

23. The factory-built structure of claim 19, further comprising a support attached to the solar module, wherein the support includes a plurality of bars that are attached at links.

24-26. (canceled)

27. A structure comprising:
a factory-built structure that is assembled at a first location and shipped to a second location;
a sub-structure comprising:
a solar module; and
a mount attached to the factory-built structure and the solar module, the solar module movable relative to the factory-built structure between a first position and a second position,
the solar module stowed adjacent the factory-built structure when the solar module is in the first position, and
the solar module extending outward from the factory-built structure when the solar module is in the second position.

28-36. (canceled)
